(19) United States
(12) Patent Application Publication
(10) Pub. No.: US 2025/0259293 A1
(43) Pub. Date: Aug. 14, 2025

(54) COMPUTER IMPLEMENTED METHOD FOR THE DETECTION OF DEFECTS IN AN IMAGING DATASET OF AN OBJECT COMPRISING INTEGRATED CIRCUIT PATTERNS, COMPUTER-READABLE MEDIUM, COMPUTER PROGRAM PRODUCT AND A SYSTEM MAKING USE OF SUCH METHODS

(71) Applicant: Carl Zeiss SMT GmbH, Oberkochen (DE)

(72) Inventors: Anna Alperovich, Neu-Ulm (DE); Alexander Freytag, Erfurt (DE); Bjoern Froehlich, Jena (DE); Bjoern Barz, Jena (DE); Jagdish Saraswatula, Aalen (DE)

(21) Appl. No.: 19/194,331

(22) Filed: Apr. 30, 2025

Related U.S. Application Data
(63) Continuation of application No. PCT/EP2024/051686, filed on Jan. 24, 2024.

(30) Foreign Application Priority Data
Feb. 4, 2023 (DE) 102023102754.9

(51) Int. Cl. G06T 7/00; G06T 7/187; G06V 10/82; G06V 10/88

(52) U.S. Cl. CPC G06T 7/0006; G06T 7/187; G06V 10/82; G06V 10/88; G06T 2207/20084; G06T 2207/30148

(57) ABSTRACT

The invention relates to a computer implemented method for the detection of defects in an imaging dataset of an object comprising integrated circuit patterns, the method comprising: obtaining an imaging dataset of the object; applying an autoencoder neural network to the imaging dataset to obtain a reconstruction of the imaging dataset; obtaining an anomaly dataset by comparing the imaging dataset to the reconstruction of the imaging dataset; applying a defect identification method to the anomaly dataset to obtain defect detections by use of a defect criterion, wherein the defect identification method comprises generating an irregularity mask indicating irregular patterns in the integrated circuit patterns of the object. The invention also relates to a corresponding computer-readable medium, computer program product and a system.

### CROSS-REFERENCE TO RELATED APPLICATIONS

This application is a continuation of and claims benefit under 35 U.S.C. § 120 from PCT Application PCT/EP2024/051686, filed on Jan. 24, 2024, which claims priority from German Application 10 2023 102 754.9, filed on Feb. 4, 2023. The entire contents of each of these earlier applications are incorporated herein by reference.

### TECHNICAL FIELD

The invention relates to systems and methods for quality assurance of objects comprising integrated circuit patterns, more specifically to a computer implemented method, a computer-readable medium, a computer program product and a corresponding system for defect detection in an imaging dataset of such an object. Based on the reconstruction of the imaging dataset by an autoencoder neural network anomalies can be detected by comparing the imaging dataset to the reconstruction of the imaging dataset. The method, computer-readable medium, computer program product and system can be utilized for quantitative metrology, process monitoring, defect detection and defect review in objects comprising integrated circuit patterns, e.g., in photolithography masks, reticles or wafers.

### BACKGROUND

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. One of the most crucial steps is the photolithography process.

Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus variation, etc.

Chips are predominantly of two types: memory or logic. Therefore, for generating memory structures photolithography masks contain mainly simple, repetitive structures such as lines, spaces, contact holes, corners, etc., and for generating logic operations photolithography masks contain complex polygon structures, often without repetitions or re-occurring sub-patterns.

Photolithography mask inspection needs to be done at multiple points in time in order to improve the quality of the photolithography masks and to maximize their usage cycles.

Once the photolithography mask is fabricated according to the requirements, an initial quality assessment of the photolithography mask is done at the mask house before it is shipped to the wafer fab. Semiconductor device design and photolithography mask manufacturing quality are verified by different procedures before the photolithography mask enters a semiconductor fabrication facility to begin production of integrated circuits. The semiconductor device design is checked by software simulation to verify that all features print correctly after photolithography in manufacturing. The photolithography mask is inspected for defects and measured to ensure that the features are within specification. The data gathered during this process becomes the golden baseline or reference for further inspections to be performed at the mask house or wafer fab. Any defects found on the photolithography mask are validated using a review tool followed by a decision of sending the photolithography mask for repair or decommissioning the mask and ordering a new one.

At the wafer fab, the photolithography mask is scanned to find additional defects called “adders” compared to the last scan performed at the mask house. Each of these adders is analyzed using a review tool. In case of a particle defect, the particle is removed. In case of a pattern-based defect the photolithography mask is either repaired, if possible, or replaced by a new one. The inspection process is repeated after every few photolithography cycles.

Each defect in the photolithography mask can lead to unwanted behavior of the produced wafer, or a wafer can be significantly damaged. Therefore, each defect must be found, classified and repaired if possible and necessary.

Tighter pitch constraints imposed by the mask designer rules make the inspection of photolithography masks very difficult due to the limited physical resolution of the optical inspection tools with the defect size being close to the resolution limits, and due to the limited throughput of the charged particle beam systems.

Reliable and fast defect detection methods are, therefore, important for photolithography masks.

Apart from defect detection in photolithography masks, defect detection in wafers is also crucial for quality management. During the manufacturing of wafers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition etc. Therefore, a quality assurance process and a quality control process is important for ensuring high quality standards of the manufactured wafers.

Apart from quality assurance and quality control, defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus variation, etc., with different dies of the wafer being exposed to different manufacturing conditions. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment. Reliable and fast defect detection methods are, therefore, important for objects comprising integrated circuit patterns.

An object comprising integrated circuit patterns can refer, for example, to a photolithography mask, a reticle or a wafer. In a photolithography mask or reticle the integrated circuit patterns are mask structures used to generate semiconductor patterns in a wafer during the photolithography process. In a wafer the integrated circuit patterns are semiconductor structures, which are imprinted on the wafer during the photolithography process.

In order to analyze large amounts of data requiring large amounts of measurements to be taken, machine learning methods can be used. Machine learning is a field of artificial intelligence. Machine learning methods generally build a parametric machine learning model based on training data consisting of a large number of samples. After training, the method is able to generalize the knowledge gained from the training data to new previously unencountered samples, thereby making predictions for new data. There are many machine learning methods, e.g., linear regression, k-means, support vector machines, neural networks or deep learning approaches.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional or pooling layers.

Methods for the automatic detection of defects in objects comprising integrated circuit patterns include anomaly detection algorithms, which are often based on a die-to-die, die-to-database or intra-die principle.

The die-to-die principle compares images of portions of an object with reference images of the same portions of another identical object. The discovered deviations are treated as defects.

However, this method requires the availability and time-consuming scanning of two corresponding portions of objects and exact knowledge about their relative positions. In addition, it fails in case of repeater defects.

The die-to-database principle compares an image location of an object with a reference image from a database, e.g., a previously recorded image or a simulated image or a CAD file, thereby discovering deviations from the ideal data. Unexpected patterns in the imaging dataset are detected due to large differences. Repeater defects can be handled, but die-to-database methods are highly computationally expensive due to the sizes and structures of the reference images. In addition they require spatial registration of the imaging datasets to be compared. Finally, reference images are not always available.

An approach similar to the die-to-die principle is the intra-die principle, which compares locations comprising design-identical structures within a single object. Thus, in this case, the reference image stems from the same object. This method is only applicable to repetitive structures, e.g., for memory array inspection, and, thus, barely for logical structures. In addition, the structures surrounding the design-identical structures at two different positions need to be larger than the point spread function (PSF) of the optical system in order to avoid proximity effects from surrounding structures during imaging of the identical patterns. These proximity effects can often not be corrected by optical proximity correction. Therefore, in practice, intra-die methods are often not applicable. Furthermore, knowledge and spatial registration of the design-identical structures is required, which is especially difficult to obtain for position-dependent photolithography behavior (e.g., position-variant PSFs).

All these methods require the availability of reference images, i.e., of images obtained from outside of the defect detection method, e.g., by an image acquisition system or by a computer model such as a CAD file, comprising integrated circuit patterns serving as reference for the integrated circuit patterns of the imaging dataset to be inspected. Reference images are hard or sometimes even impossible to obtain and often lead to high computational effort during integrated circuit pattern comparison, e.g., due to registration.

To mitigate these drawbacks, methods according to the single-die principle have been used. Single-die methods do not require the availability of reference images during inspection. Instead, only the imaging dataset to be inspected is required during the defect detection process.

U.S. Pat. No. 9,008,410 B2, for example, discloses a single-die method for wafer inspection during which the same location on a die is imaged several times with different imaging settings. Locations exhibiting stark variations over the different settings are considered as anomalies. Yet, the imaging settings require careful adjustment, and the method is restricted to defect inspection of wafers with darkfield illumination tools.

Yet, not all anomalies are defects: for instance, anomalies can also include, e.g., imaging artefacts, image acquisition noise, varying imaging conditions, variations of the integrated circuit patterns within the norm, rare integrated circuit patterns, etc. Such anomalies that are not detrimental to the functioning of the semiconductor device are referred to as false positives in the following. It is, therefore, important to discriminate between defects and false positives. Ideally, all defects in the object are detected but none of the false positives to ensure high quality standards but prevent too many objects unnecessarily marked as rejects at the same time.

The article “W. Tang, C. Vian, Z. Tang, B. Yang; Anomaly detection of core failures in die casting X-ray inspection images using a convolutional autoencoder; Machine Vision and Applications, 2021, No. 32, p. 102” describes a method for detecting defects in X-ray images obtained during die casting. The method uses a trained autoencoder to reconstruct the X-ray image. A difference image is computed between the original X-ray image and the reconstructed X-ray image. A sliding window technique with two different thresholds is then applied to the difference image to detect defects. To prevent the detection of noise, edge locations are ignored when using the lower threshold. However, many false positive defect detections of an autoencoder such as irregular patterns are not due to noise and, thus, do not lie on image edges.

WO 2022/058 264 A1 describes a method for detecting defects in images of wafers that reduces the number of false positive defect detections. The method assigns semiconductor structures in a wafer image to a number of base classes using a CAD file. For each base class, “finger print data” is prepared in a database that indicates correct semiconductor structures for the respective base class. Instead of using CAD crops for the finger print data, crops of acquired wafer images are used. In this way, deviations from the design that nevertheless are not understood as defects but are due to the manufacturing process, e.g., rounded corners or edge roughness, are not detected as defects. However, this method is not a single-die method as it requires a CAD file. Furthermore, the assignment of semiconductor structures to base classes is time-consuming and error-prone.

It is, therefore, an aspect of the invention to provide a single-die defect detection method for the inspection of objects comprising integrated circuit patterns that reduces the number of false positive defect detections. It is another aspect of the invention to improve the accuracy of defect detection methods for inspection of such objects. It is another aspect of the invention to distinguish defects from false positives. Another aspect of the invention is to increase the throughput of defect detection methods for objects comprising integrated circuit patterns. Another aspect of the invention is to improve the accuracy and/or the runtime of defect detection methods for objects comprising integrated circuit patterns. Another aspect of the invention is to provide a defect detection method, which is accessible to non-expert users. Another aspect of the invention is to improve the applicability of single-die object inspection methods to irregular patterns such as logical structures. Another aspect of the invention is to provide a defect detection method, which is adaptable to specific use-cases and can be used for different types of imaging datasets of variable complexity.

These aspects are achieved by the invention specified in the independent claims. Advantageous embodiments and further developments of the invention are specified in the dependent claims.

### SUMMARY

Embodiments of the invention concern computer implemented methods, computer-readable media, computer program products and systems implementing defect detection methods for objects comprising integrated circuit patterns.

An embodiment of the invention involves a computer implemented method for the detection of defects in an imaging dataset of an object comprising integrated circuit patterns, the method comprising: obtaining an imaging dataset of the object; applying an autoencoder neural network to the imaging dataset to obtain a reconstruction of the imaging dataset; obtaining an anomaly dataset by comparing the imaging dataset to the reconstruction of the imaging dataset; and applying a defect identification method to the anomaly dataset to obtain defect detections by use of a defect criterion, in particular to distinguish between defects and false positives. The defect identification method comprises generating an irregularity mask indicating irregular patterns in the integrated circuit patterns of the object. The detected defects can, for example, be used for repair of the object, for a modification of the manufacturing process, for metrology, for a qualitative assessment of the object, for a decision if the object must be discarded, or for process window qualification.

The term “object” refers to a photolithography mask, a reticle or a wafer. In case of a photolithography mask, the photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

Throughout this specification, the term “imaging dataset” can refer to images comprising the integrated circuit patterns of the whole object. It can also refer to images of only a subset of the integrated circuit patterns of the object, e.g., to a spatial subset, for example to an area of interest of the object. The imaging dataset can refer to a single image, in particular to an area of interest of a single image. The imaging dataset can refer to two or multiple images, in particular to an area of interest within each of the images. For example, the imaging dataset can comprise several hundred or several thousand or several ten thousand images. The imaging dataset can be acquired in different ways, e.g., by a charged particle beam system such as a scanning electron microscope (SEM) or a focused ion beam (FIB) microscope or by an atomic force microscope (AFM) or by an aerial image measurement system, e.g., equipped with a staring array sensor or a line-scanning sensor or a time-delayed integration (TDI) sensor. The term “a number of” can refer to one or more. The term “a subset of a dataset” can refer to a portion of the dataset or to the whole dataset.

The reconstruction of the imaging dataset by use of the autoencoder replaces the typically used reference images. As no reference image is obtained from outside of the computer implemented method, the method is a single-die method. Since neither a reference image is required nor a registration of the reference image for aligning the reference image to the imaging dataset, runtime and resources are saved and the throughput of the computer implemented method is increased. Since the application of the autoencoder is computationally inexpensive, the method can be used in real-time inline applications as well as for offline applications. In addition, a single scan of the object areas of interest is sufficient to detect anomalies of any type, such as particles, shorts and opens.

The defect identification method comprises generating an irregularity mask indicating irregular patterns in the integrated circuit patterns of the object. These irregular patterns often cannot be reliably reconstructed by the autoencoder and, thus, often lead to false positives. Regular patterns comprise structures or combinations of structures which repeatedly occur in the same layout of integrated circuit patterns. Irregular patterns comprise non-repetitive structures of integrated circuit patterns. For example, irregular patterns comprise but are not limited to non-continuous lines, line endings or bridges. Such irregular patterns are often found in logic patterns. By identifying these irregular patterns by use of the irregularity mask, these irregular patterns can be handled in a different way, e.g., they can be ignored during defect detection to avoid false positives, or a second defect detection method can be applied to the irregular patterns. In this way, the accuracy of single-die defect detection methods can be improved, especially for irregular patterns.

According to an example of an embodiment of the invention, the autoencoder neural network has been trained comprising the following steps: generating autoencoder training data from imaging datasets of objects comprising integrated circuit patterns and iterating the following steps: selecting one or more hyperparameter values for one or more hyperparameters of an autoencoder neural network according to a sampling strategy; training the autoencoder based on subsets of the generated autoencoder training data and the selected one or more hyperparameter values; evaluating the trained autoencoder by computing an associated objective function value of an objective function. Finally, one of the trained autoencoders is selected based on the associated objective function value.

By using one or more use-case specific metrics in the objective function the trained autoencoder is able to generate reconstructions of imaging datasets including many details but no defects, thus improving the accuracy of the defect detection. Since the hyperparameter values of the autoencoder are optimized automatically, expert knowledge is not required during training of the network. Therefore, the method is easy to use and, thus, accessible to non-expert users. Due to the automatic hyperparameter optimization, the proposed method is adaptive to different use-cases and can be applied to different types of imaging datasets of variable complexity.

According to an aspect of the example of the embodiment of the invention, the generated autoencoder training data comprises expert annotations of defects in the imaging datasets of objects comprising integrated circuit patterns. Such expert annotations can be used in different ways during training of the autoencoder. They allow to obtain defect detections by use of a defect criterion, in particular to distinguish defects from false positives, thus improving the accuracy of the defect detection method due to only few false positive detections.

According to an example, a subset of the expert annotations is used as validation data during the training of the autoencoder. In this way, the ability of the autoencoder to obtain defect detections by use of a defect criterion, in particular to distinguish defects from false positives, is monitored during training. In addition, training can be stopped before the autoencoder learns to reconstruct defects. Thus, the accuracy of the defect detection method is improved.

According to an example, the objective function comprises a segmentation metric term comparing a subset of the anomaly dataset to a subset of the expert annotations of the defects. In this way, the hyperparameter values of the autoencoder, e.g., the layout of the autoencoder, are selected preventing the autoencoder from reconstructing defects but allowing for sufficiently complex layouts to allow for a detailed reconstruction of the imaging dataset, thus improving the accuracy of defect detection results.

According to an example, the objective function comprises a weighted sum of at least two terms measuring different properties of the trained autoencoder. Since the objective function contains more than one term, it simultaneously optimizes different criteria, so the resulting autoencoder is not merely trained to reconstruct the imaging dataset but fulfills other criteria at the same time.

According to an aspect of the example of the embodiment of the invention, the objective function comprises an Lₚ-norm metric term for p≥1 measuring the deviation of the imaging dataset from the reconstruction of the imaging dataset. In this way, the autoencoder is trained to reconstruct the imaging dataset as closely as possible.

According to an aspect of the example of the embodiment of the invention, the objective function comprises a term measuring the computation time of a forward pass of the trained autoencoder. Since the objective function takes into account the computation time, the autoencoder can be optimized for runtime, which is especially useful for real-time applications.

According to an aspect of the example of the embodiment of the invention, the objective function comprises a term measuring the complexity of the trained autoencoder. By favoring less complex autoencoder models, overfitting to the training data can be avoided. In addition, the runtime of the autoencoder can be reduced leading to a higher throughput. Also, the compatibility of the defect detection method in case of limited hardware resources can be promoted.

According to an aspect of the example of the embodiment of the invention, the objective function comprises a term measuring the compatibility of the trained autoencoder with a specific hardware. Thus, the autoencoder can be optimized with respect to a specific system comprising the specific hardware.

According to an aspect of the example of the embodiment of the invention, the objective function comprises an Lₚ-norm metric term for p≥1 measuring the deviation of the imaging dataset from the reconstruction of the imaging dataset, a segmentation metric term comparing a subset of the anomaly dataset to a subset of the expert annotations of the defects, and a term measuring the complexity of the trained autoencoder. By combining at least these three criteria, the trained autoencoder is of limited complexity and able to reliably reconstruct the imaging dataset but not the defects.

According to an aspect of the example of the embodiment of the invention, the objective function comprises a quality term evaluating the quality of the trained autoencoder, wherein a user interface is configured to present information on the trained autoencoder to a user and let the user indicate the value of the quality term. In this way, the training of the autoencoder becomes accessible to non-expert users who can simply judge the quality of the reconstructions of the autoencoder without requiring further knowledge of the hyperparameter selection process. In addition, the user interface can be configured to monitor the progress of the autoencoder training, so the user can intervene, if necessary, by defining the quality term of the objective function via the user interface.

The imaging dataset is compared to the reconstruction of the imaging dataset obtained by applying the autoencoder to the imaging dataset. The resulting anomaly dataset usually includes many anomalies which would lead to false positives. For example, the anomaly dataset includes defects and false positives alike. In order to reduce the number of false positives, a defect identification method is applied to the anomaly dataset.

According to an example of an embodiment of the invention, the defect identification method comprises a defect segmentation method. The defect segmentation method can be used for postprocessing the anomaly detection results to obtain defect detections by use of a defect criterion, in particular to distinguish defects from false positives, thus improving the accuracy of the defect detection method.

According to an aspect of the example of the embodiment of the invention, the defect segmentation method comprises applying a region growing algorithm to a smoothed anomaly dataset. The smoothing operation filters out noise and spurious deviations of the imaging dataset from the reconstruction of the imaging dataset, while the region growing algorithm detects complete defect instances by computing their connected components. Thus, the accuracy of the defect detection method is improved.

According to an aspect of the example of the embodiment of the invention, the defect segmentation method comprises applying a machine learning segmentation model, in particular a deep learning segmentation model, to the anomaly dataset. In this way, the machine learning segmentation model can be specifically trained on training data to obtain defect detections by use of a defect criterion, in particular to distinguish defects from false positives. Such machine learning segmentation models, in particular deep learning segmentation models, are highly accurate and easy to apply as they do not require the selection of parameters such as thresholds or smoothing strength, etc. Hyperparameter optimization techniques can be applied as well.

Single-die methods come with the problem of generating a suitable replacement of a reference image for comparison. One way of obtaining such a replacement is machine learning as described above. Yet, such machine learning approaches can only learn from what is included in the training data. Regular patterns can easily be learned by such approaches. However, irregular patterns, e.g., logical patterns, are often underrepresented in the training data or not included at all. Therefore, another aspect of the invention is to make single-die object inspection methods applicable to irregular patterns.

According to an example, obtaining the irregularity mask comprises comparing a model design of the object to a regularized model design of the object, wherein the regularized model design is obtained from the model design by replacing irregular patterns by regular patterns.

According to an example, obtaining the regularized model design comprises applying a machine learning model to the model design of the object, the machine learning model being trained to replace irregular patterns by regular patterns. This is beneficial, since the regularized model design can be generated automatically by machine learning methods, e.g., by use of another autoencoder trained on regular patterns, thus, saving a lot of user effort.

According to an example, obtaining the regularized model design comprises using a user interface configured for letting a user indicate regularized patterns of the model design. This way of obtaining a regularized model design does not require any additional algorithms and prevents errors in the definition of regularized patterns.

According to an example, obtaining the regularized model design comprises loading data from a database. The regularized model design can also be included in the model design. This way of providing a regularized model design is especially simple since neither additional algorithms nor user effort is required for identifying irregular patterns and replacing them by regular patterns. In addition, errors are prevented, since the designer indicates the regularized patterns instead of the user or an algorithm.

According to an example, obtaining the irregularity mask comprises applying a logical XOR function to the model design of the object and the regularized model design of the object. In this way, integrated circuit patterns appearing only in the model design or only in the regularized design are marked as irregular, allowing for the detection of missing or additional structures at the same time, thus improving the accuracy of the method.

According to an example, obtaining the irregularity mask comprises applying a machine learning model to the model design of the object, the machine learning model being trained to identify irregular patterns. In this way, the irregularity mask is obtained directly from the model design.

For example, obtaining the irregularity mask can comprise loading data from a database. The irregularity mask can also be included in the model design. This way of providing the irregularity mask is especially simple since neither additional algorithms nor user effort is required for the detection of irregular patterns. In addition, errors are prevented due to the designer indicating the irregular patterns instead of the user or an algorithm.

Obtaining the irregularity mask can also comprise using a user interface configured for letting a user indicate irregular patterns of the model design. This way of obtaining an irregularity mask does not require any additional algorithms and prevents errors in the definition of irregular patterns.

The irregularity mask can be used in different ways.

According to an example of an embodiment of the invention, the defect identification method ignores defects occurring within the irregular patterns indicated by the irregularity mask. Thus, the irregularity mask is used as a filter to prevent false positives, thereby improving the accuracy of the method.

According to an example of an embodiment of the invention, the defect identification method comprises an irregular defect detection method for the detection of defects in irregular patterns, which is applied to the irregular patterns indicated by the irregularity mask. By using a separate irregular defect detection method for the irregular patterns, it becomes possible to correctly detect defects within these irregular patterns. By using the irregular defect detection method, not only false positive but also false negative defect detections are prevented within irregular patterns.

For example, the irregular defect detection method for the detection of defects in irregular patterns can comprise the application of a machine learning model, in particular a second autoencoder, trained on training data comprising irregular patterns. Preferably, the training data comprises predominantly irregular patterns, in particular at least 90% of the training data comprises irregular patterns. The machine learning model can be designed according to any of the examples or aspects described above. In this way, a single-die method becomes available for the inspection of irregular patterns including all the advantages described for the single-die defect detection method above.

According to an example, the training data is generated from irregular patterns indicated by irregularity masks of imaging datasets of objects and/or of model designs of objects. In this way, the machine learning model is able to learn to detect defects in irregular patterns.

According to an embodiment of the invention, subsets of the imaging dataset are successively acquired, in particular via time-delayed integration, and for each acquired subset defects are detected in an online fashion, e.g., during the manufacturing process. This allows for fast detection of defects required in online systems and increases the throughput.

According to an example of the invention, obtaining defect detections comprises distinguishing defects from false positives.

According to an example, the autoencoder is trained using simulated imaging datasets of the object for a first number of training cycles and using acquired imaging datasets of the object for a second number of training cycles. In this way, time and effort is saved during training, since less acquired imaging datasets are required for training.

According to an example of the invention, the imaging dataset of the object is obtained by an image acquisition method from the group comprising time-delayed integration, x-ray imaging, scanning electron microscopy, focused ion beam microscopy, atomic force microscopy, aerial imaging.

According to an embodiment of the invention, one or more measurements of the detected defects are determined, in particular size, area, dimension, shape parameters, distance, radius, aspect ratio, type, number of defects, location, density, spatial distribution of defects, existence of defects, etc. This allows for carrying out metrology tasks and for rule-based quality assessment of the object.

The invention also involves a computer-readable medium, having stored thereon a computer program executable by a computing device, the computer program comprising code for executing any of the methods described above.

The invention also involves a computer program product comprising instructions which, when the program is executed by a computer, cause the computer to carry out any of the methods described above.

The invention also involves a system for inspecting an object comprising integrated circuit patterns for defects comprising: an imaging device adapted to provide an imaging dataset of an object comprising integrated circuit patterns; one or more processing devices; one or more machine-readable hardware storage devices comprising instructions that are executable by one or more processing devices to perform operations comprising a method of any of the methods described above.

The invention described by examples and embodiments is not limited to the embodiments and examples but can be implemented by those skilled in the art by various combinations or modifications thereof.

### BRIEF DESCRIPTION OF DRAWINGS

FIG. 1 shows an imaging dataset of an object comprising integrated circuit patterns in the form of a photolithography mask comprising a defect;

FIG. 2 shows a flowchart illustrating the steps of an embodiment of the invention;

FIG. 3 shows an example architecture of an encoder of a deep fully-convolutional autoencoder;

FIG. 4 shows the computation of a reconstruction of an imaging dataset by applying an autoencoder;

FIG. 5A shows the detection of anomalies by use of an autoencoder in case of a defect-free imaging dataset;

FIG. 5B shows the detection of anomalies by use of an autoencoder in case of an imaging dataset containing a defect;

FIG. 6 illustrates the need for careful hyperparameter tuning of the autoencoder neural network and the training process;

FIG. 7 shows a flowchart of a hyperparameter optimization method according to an example of an embodiment of the invention;

FIG. 8 illustrates a hyperparameter optimization method according to an example of an embodiment of the invention;

FIG. 9 illustrates a defect identification method comprising the application of a region growing algorithm to a smoothed anomaly dataset;

FIG. 10 illustrates a defect identification method comprising the application of a machine learning segmentation model, in particular a deep learning segmentation model, to an anomaly dataset;

FIG. 11 shows a flowchart of a defect identification step according to an embodiment of the invention;

FIGS. 12A-12F illustrate the steps of the defect identification step illustrated in FIG. 11 for an example object comprising integrated circuit patterns;

FIG. 13 illustrates the application of an irregular defect detection method 103 to an irregular pattern; and

FIG. 14 schematically illustrates a system, which can be used for inspecting an object comprising integrated circuit patterns for defects.

### DETAILED DESCRIPTION

In the following, advantageous exemplary embodiments of the invention are described and schematically shown in the figures. Throughout the figures and the description, same reference numbers are used to describe same features or components.

FIG. 1 shows an imaging dataset 10 of an object 116 comprising integrated circuit patterns in the form of a photolithography mask comprising a defect 12. Methods known from the art often use die-to-die, die-to-database or intra-die methods to detect such defects 12. However, all these methods require the availability of reference images, either from a second die with identical integrated circuit patterns of the same object or another object or from a database of acquired or simulated model images. Such reference images are often hard to obtain and lead to high computational efforts during integrated circuit pattern comparison. In addition, false positives 76 due to, e.g., image acquisition noise or varying imaging conditions or minor structure variations, do not lead to defective wafers and, therefore, should be ignored during object inspection. Furthermore, defect detection methods often yield a number of false positives 76. Therefore, it is an aspect of the invention to provide a single-die defect detection method for objects 116, which is able to reduce the number of false positives 76, in particular to differentiate between defects 12 and false positives 76.

An object 116 comprising integrated circuit patterns can refer, for example, to a photolithography mask, a reticle or a wafer. In a photolithography mask or reticle the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

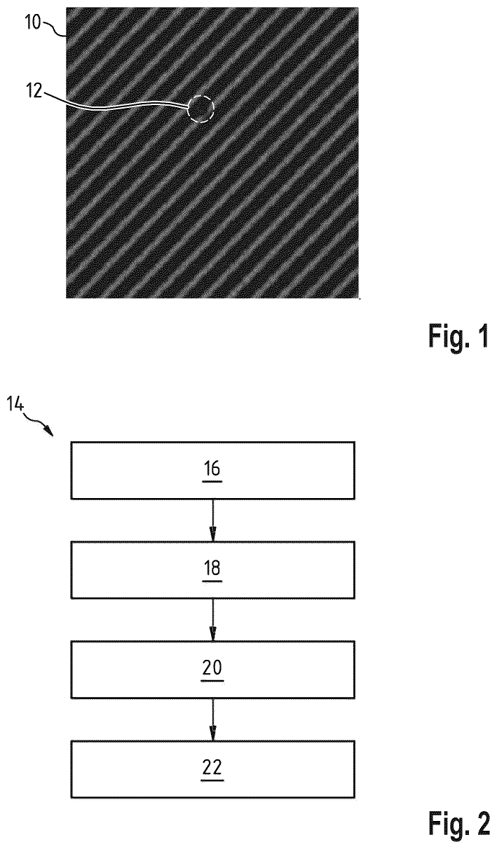

FIG. 2 shows a flowchart illustrating the steps of an embodiment of the invention. The computer implemented method 14 for the detection of defects 12 in an imaging dataset 10 of an object 116 comprising integrated circuit patterns comprises: obtaining an imaging dataset 10 of the object 116 in an image acquisition step 16; applying an autoencoder 24 neural network to the imaging dataset 10 to obtain a reconstruction 26 of the imaging dataset 10 in a reconstruction step 18; obtaining an anomaly dataset 28 by comparing the imaging dataset 10 to the reconstruction 26 of the imaging dataset 10 in an anomaly detection step 20; applying a defect identification method 72 to the anomaly dataset 28 to obtain defect detections 73 by use of a defect criterion, in particular to distinguish defects 12 from false positives 76, in a defect identification step 22, wherein the defect identification method 72 comprises generating an irregularity mask 90 indicating irregular patterns 104 in the integrated circuit patterns of the object 116. The detected defects 12 can, for example, be used in a quality assurance system, as a first step in an object repair system or for process window qualification.

An autoencoder 24 neural network is a type of artificial neural network used in unsupervised learning, also referred to as self-supervised learning, to learn efficient representations of unlabeled data. An autoencoder 24 comprises two main parts: an encoder 32 that maps the input 34 into a code, and a decoder that maps the code to a reconstruction 26 of the input 34. The input 34 of the autoencoder can, for example, comprise a greyscale or multichannel imaging dataset 10. The encoder 32 neural network and the decoder neural network can be trained to minimize a difference between the reconstruction 26 of the input 34 and the input 34 itself. The code typically is a representation of the input 34 with lower dimensionality and can, thus, be viewed as a compressed version of the input 34. For this reason, autoencoders 24 are forced to reconstruct the input 34 approximately, preserving only the most relevant aspects of the input 34 in the reconstruction 26.

Therefore, autoencoders 24 can be used for the detection of anomalies 36. Anomalies 36 generally concern rare deviations from the norm within an imaging dataset 10. Due to the rarity of their occurrence the autoencoder 24 will not reconstruct this kind of information, thus suppressing anomalies 36 in the reconstruction 26. Anomalies 36 can then be detected by comparing the imperfect reconstruction 26 of the imaging dataset 10 to the imaging dataset 10. The larger the difference between them, the more likely an anomaly 36 is present. Anomalies 36 can be used as defect indicators.

Instead of applying the autoencoder 24 to the full imaging dataset 10, the imaging dataset 10 can be subdivided into smaller subsets. The autoencoder 24 can then be applied to each of the subsets separately. In another example, different autoencoders 24 can be trained for different subsets of the imaging dataset 10. For example, each autoencoder 24 can represent a different pattern in the imaging dataset 10. Together, these autoencoders can reconstruct diverse patterns of the imaging datasets 10. In this way, the required complexity of the autoencoder is reduced due to the reduced size of the input 34, thus improving the accuracy of the results.

In order to make the training and application of the autoencoder and any other machine learning model described herein efficient, specific hardware such as graphics processing units (GPUs), field programmable gate arrays (FPGAs) or tensor processing units (TPUs) can be used.

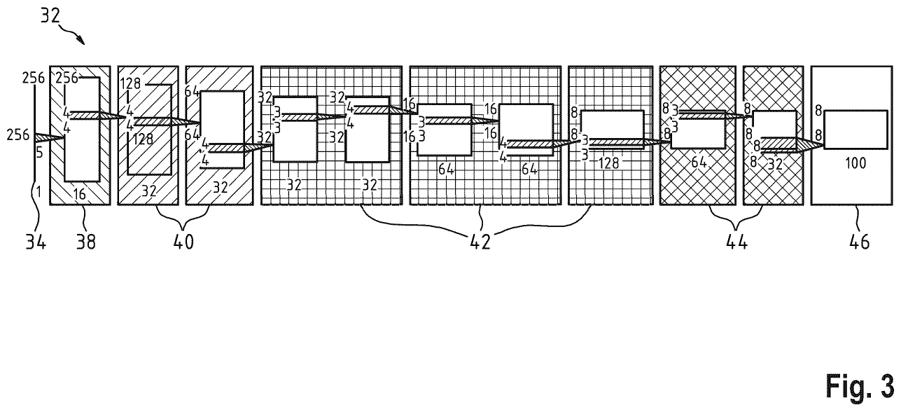

FIG. 3 shows an example architecture of an encoder 32 of a deep fully-convolutional autoencoder 24. The input 34 is a tile of size 256×256 pixels comprising a single channel. A stem 38 scales the input 34 to increase the channel-size to 16 based on a stack of 16 filters of spatial size 5×5. The data is then passed through a series of convolution-based downsampling blocks 40 using a stack of 32 filters of spatial size 4×4 in order to decrease the spatial resolution of the data, while the number of channels remains constant to 32. The data is then passed through a series of downsampling and channel expansion blocks 42 reducing the spatial resolution to 8×8 and increasing the channel-size to 128. Then the data is compressed by channel compression layers 44 reducing the channel-size to 32. The bottleneck 46 finally connects all available information. Let K be the total number of downsampling operations applied to the input and let N be the number of downsampling and channel expansion blocks 42. Then the number of downsampling blocks 40 is K−N, and the number of channel compression layers 44 is N−1. The decoder (not shown here) usually is the exact mirror of the encoder blocks. However, this is not a requirement. Encoder and decoder can, for example, be of different size, different depth or different architecture, etc. The decoder can also be asymmetric, for example concerning width versus height, e.g., for special sizes of the input 34. This is, for example, useful during online applications where subsets of the imaging dataset 10 are processed whenever they are available, leading to input sizes with strongly differing width and height, e.g., 4k×64 px for time-delayed integration image acquisition methods.

Instead of using the raw data of the imaging dataset 10 as input 34, feature vectors can be generated from the raw data and used as input 34, e.g., edge images, histograms of oriented gradients (HoG), scale invariant feature transforms (SIFT) or stacks of filter responses, e.g., of Gabor filters. In this way, the accuracy of the defect detection method can be improved.

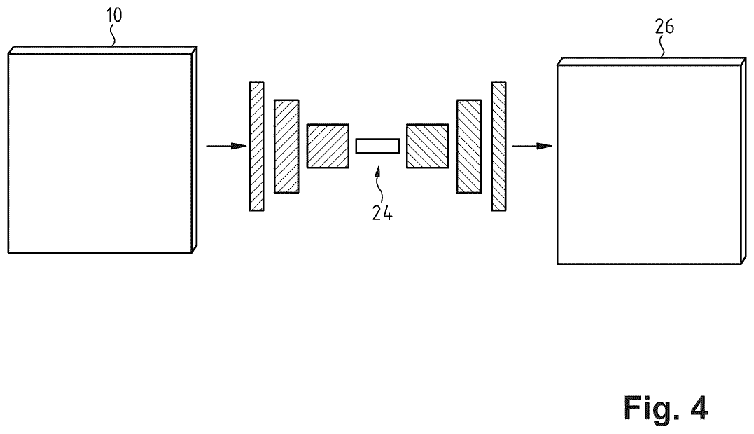

FIG. 4 shows the computation of a reconstruction 26 of an imaging dataset 10 by applying an autoencoder 24. The imaging dataset 10 is presented as input 34 to the autoencoder 24. The autoencoder computes a reconstruction of the imaging dataset 10 based on its knowledge gained from the autoencoder training data 66. Therefore, rarely occurring details of the imaging dataset 10, such as defects 12, are not reconstructed and, thus, not contained in the reconstruction 26.

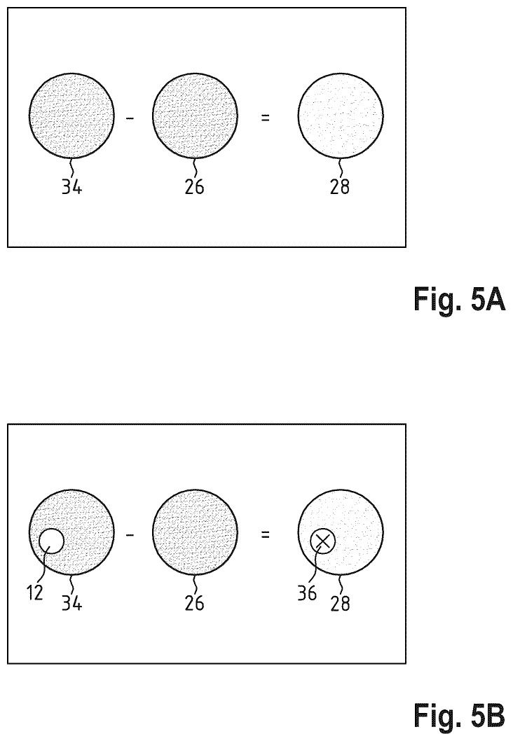

FIG. 5A shows the application of an autoencoder 24 to a defect-free imaging dataset 10. The input 34 is defect-free. Therefore, the reconstruction 26 of the input 34 by the autoencoder 24 is identical or nearly identical to the input 34. The anomaly dataset 28 is the difference image of the input 34 and its reconstruction 26, which is zero or close to zero indicating no defects 12.

FIG. 5B shows the detection of anomalies 36 by use of an autoencoder 24 in case of an imaging dataset 10 containing a defect 12. The input 34 contains a defect 12. Therefore, the reconstruction 26 of the input 34 by the autoencoder 24 is not identical to the input 34 in the location of the defect 12. The anomaly dataset 28 is the difference image of the input 34 and its reconstruction 26, which shows an anomaly 36 in the form of a larger deviation from zero indicating the presence of a defect 12. The detected anomalies 36 can be marked as defect detections, or they can be postprocessed to reduce the number of false positives 76.

The autoencoder 24 can be trained offline on defect-free or mostly defect free imaging datasets 10 containing identical or similar integrated circuit patterns or integrated circuit patterns representative of the patterns expected in the object 116. Mostly defect free here means that less than 5% of the imaging dataset 10 comprise defects 12. The imaging datasets used for training can be acquired imaging datasets 10 of objects 116, simulated imaging datasets 10 or computer-generated models, e.g., CAD files stored in a database 130. In an example, the autoencoder 24 is trained using simulated imaging datasets of the object 116 for a first number of training cycles and using acquired imaging datasets 10 of the object 116 for a second number of training cycles. In particular, the second number of training cycles can follow the first number of training cycles.

In another example, the training data comprises both simulated imaging datasets and acquired imaging datasets at the same time. For simulated imaging datasets or computer-generated models, the major relevant optical effects of the image acquisition device can be simulated, e.g., rigorous simulations for 3D masks or Kirchhoff based simulations for DUV masks, noise simulations, etc. By using simulated imaging datasets or computer-generated models the amount of available training data can be significantly increased. The training data can also be specifically designed to cover relevant defect types, defect shapes, defect positions, etc. In addition, simulated imaging datasets or computer-generated models do not contain registration errors, which is not the case for acquired imaging datasets 10.

The acquired imaging datasets for training can be acquired from one or more objects, e.g., from one or more photolithography masks. The one or more objects can comprise one or more pattern types, e.g., one or more memory patterns or logical patterns. The imaging datasets can have one or more fields of view. In this way, the autoencoder 24 can be trained to reconstruct diverse imaging datasets 10. Alternatively or additionally, simulated imaging datasets 10 can be used for training, which can also comprise one or more objects, one or more pattern types and one or more fields of view. In this way, the autoencoder 24 can be trained to reconstruct diverse imaging datasets 10.

By using an autoencoder 24 trained on mostly defect-free imaging datasets 10 the autoencoder 24 is able to reconstruct the input 34 without (or with reduced) defects 12. The input 34 can be compared to the reconstruction 26 to obtain an anomaly dataset, e.g., by computing a difference image between the input 34 and its reconstruction 26. In this way, anomalies 36 can be detected in the imaging dataset 10 without requiring any reference images during operation of the computer implemented method 14, that is by a single-die method.

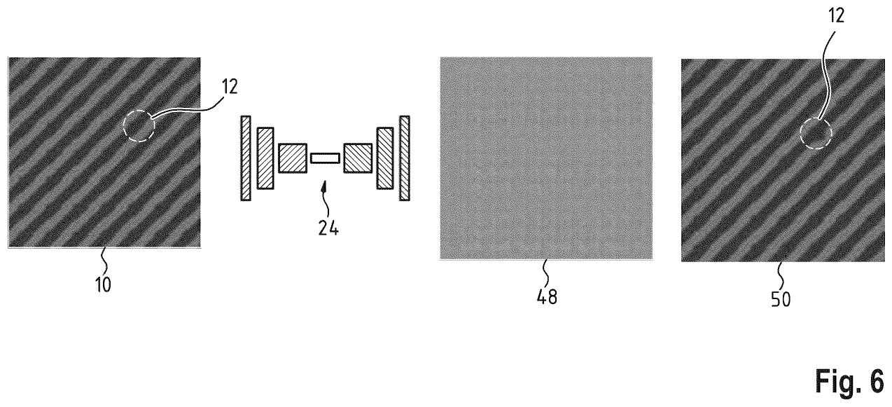

However, using an autoencoder 24 for defect detection requires careful tuning of the parameters of the autoencoder 23 neural network and the training process, that is of the so-called hyperparameters. FIG. 6 illustrates the need for careful hyperparameter tuning of the autoencoder 24 neural network and the training process. The imaging dataset 10 containing a defect 12 is the input 34 of an autoencoder 24. On the right-hand side, two reconstructions 26 of the imaging dataset 10 are shown. The first reconstruction 48 strongly differs from the imaging dataset 10 due to a too low complexity of the autoencoder 24, e.g., a too small bottleneck 46 or layers of insufficient size in terms of spatial resolution or channel-size. This prevents the autoencoder from learning important properties of the input 34, e.g., the angle and width of the diagonal line structures, which cannot be reconstructed leading to a huge number of false positives 76. The second reconstruction 50 is a perfect reconstruction 26 of the imaging dataset 10 including the defect 12. Due to a too high complexity of the autoencoder 24, e.g., a too large bottleneck 46 or layers of too large size in terms of spatial resolution or channel-size, the autoencoder learns to reconstruct defect-free data along with defects 12. In this way, many defects 12 are not detected at all. For this reason, it is important to carefully select the hyperparameters of the autoencoder 24 with respect to the application.

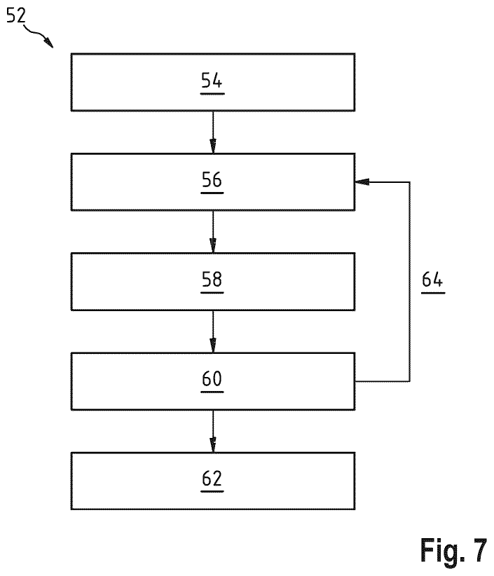

FIG. 7 shows a flowchart of a hyper parameter optimization method 52 according to an example of an embodiment of the invention. According to this example, the autoencoder 24 neural network has been trained comprising the following steps: generating autoencoder training data 66 from imaging datasets 10 of objects 116 comprising integrated circuit patterns in a training data generation step 54, and carrying out an iteration 64 of the following steps: selecting one or more hyperparameter values for one or more hyperparameters of an autoencoder 24 neural network according to a sampling strategy in a hyperparameter selection step 56; training the autoencoder 24 based on subsets of the generated autoencoder training data 66 and the selected one or more hyperparameter values in a training step 58; and evaluating the trained autoencoder 24 by computing an associated objective function value of an objective function in an evaluation step 60. Finally, one of the trained autoencoders 24 is selected based on the associated objective function value in a selection step 62.

In machine learning, a hyperparameter is a parameter whose value is used to control the learning process, but is not learned from data. By contrast, the values of other parameters (typically node weights, e.g., values of convolutional filter masks, etc.) are optimized during training on training data. Hyperparameters can be classified as model hyperparameters that refer to the structure of the machine learning model, or algorithm hyperparameters that refer to the training algorithm used to train the machine learning model and in principle have no influence on the performance of the model but affect the speed and quality of the learning process. An example of a model hyperparameter is the topology of a neural network. Examples of algorithm hyperparameters are learning rate, optimization algorithm and mini batch size. Hyperparameters of a machine learning method include both model hyperparameters and algorithm hyperparameters.

A hyperparameter can be selected from the following list of example hyperparameters, but is not limited to these:
the initial learning rate,
the learning rate decay factor,
utilization of momentum,
the number of epochs,
the regularization scale,
the size and content of the training set,
the number of convolution-based downsampling blocks (see FIG. 3),
the number of downsampling and channel expansion blocks (see FIG. 3),
the feature dimension of all blocks (see FIG. 3),
the number of layers per block,
the size of the layers,
the type of the layers,
the connections between the layers,
the type of convolution used,
the up-sampling scheme,
the filter size,
the stride of the convolutions,
the bottleneck filter size (number of features in the bottleneck),
the filter size of the first layer (the remaining filters are scaled proportionally),
the drop-out rate,
kernel sizes of convolutional layers,
utilization of Nesterov accelerated gradient,
type of optimization algorithm,
etc.

The search for optimal hyperparameters is non-trivial due to the typically long training times of autoencoders 24, the complex and often high-dimensional parameter space and the lack of predefined gradients of the objective function with respect to the hyperparameters.

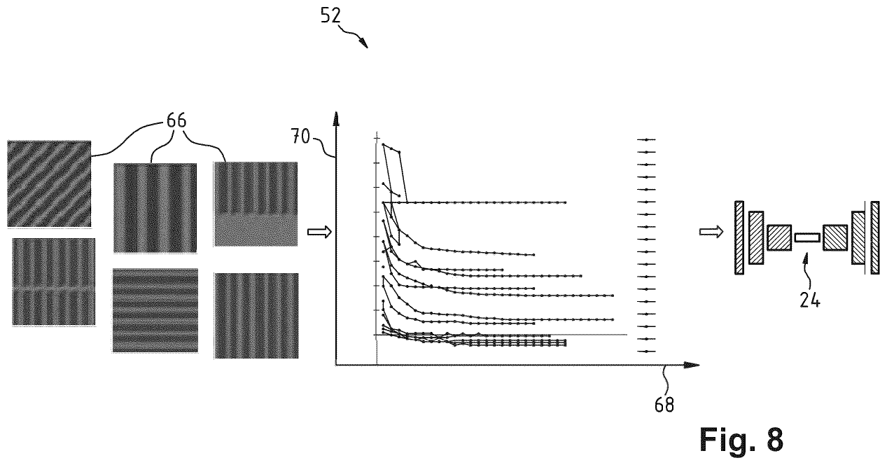

FIG. 8 illustrates a hyperparameter optimization method 52 according to an example of an embodiment of the invention. Autoencoder training data 66 is generated from imaging datasets 10. The autoencoder training data 66 can comprise mostly defect-free acquired or simulated images, from the same or other objects 116 comprising integrated circuit patterns. The hyperparameter optimization method 52 selects one or more hyperparameter values according to a sampling strategy, trains the autoencoder 24 using the autoencoder training data 66 and evaluates the objective function for the trained autoencoder 24. Then, according to the sampling strategy, the next one or more hyperparameter values are selected. The development of the objective function is monitored over time as shown in the center of FIG. 8. On the horizontal axis 68 the time is shown and on the vertical axis 70 the objective function value for the selected one or more hyperparameters of the current trial is shown. The optimization of the objective function can be carried out in parallel for different initial sets of hyperparameters (e.g., randomly selected). If no further improvement of the objective function can be obtained, a new initial set of hyperparameters can be selected. Finally, one of the trained autoencoders 24 is selected based on the associated objective function value, e.g., the one with the lowest (or highest) objective function value.

The objective function is a measure for the quality of a trained autoencoder 24 and, thus, of the one or more selected hyperparameter values associated with the trained autoencoder 24. Different sets of hyperparameter values can, thus, be compared based on their objective function values with respect to the properties measured by the objective function.

According to an aspect of the example of the embodiment of the invention, the generated autoencoder training data 66 comprises expert annotations of defects 12 in the imaging datasets 10 of objects 116 comprising integrated circuit patterns. Expert annotations can comprise, for example, pixel-wise annotations, bounding boxes, defect center locations, scribbles, etc. The provided expert annotations do not need to encompass all defects 12 or all types of defects 12 in the imaging dataset 10. Neither are the expert annotations sufficient to train a stand-alone model, e.g., less than 10%, preferably less than 1%, of the training data are expert annotations.

Expert annotations can, for example, be used in one of the following two ways or in both simultaneously:

1) A subset of the expert annotations can be used as validation data during the training of the autoencoder 24. Validation data is used for monitoring the progress of the training of the autoencoder 24, so training can be stopped before overfitting occurs. By using expert annotations of defects 12 as validation data, training can be stopped before the autoencoder 24 learns to reconstruct defects as well.

2) The objective function can comprise a segmentation metric term comparing a subset of the anomaly dataset 28 to a subset of the expert annotations of the defects 12.

The segmentation metric measures the suitability of the autoencoder 24 trained by the selected one or more hyperparameter values for defect detection. At the same time, the segmentation metric is a measure of the ability of the trained autoencoder 24 to ignore false positives 76.

Other uses of the expert annotations of defects are conceivable.

There are many options to define a segmentation metric. For example, the expert annotations of defects 12 can be represented by a (possibly binary) segmentation dataset indicating the pixel-wise presence or not-presence of a defect 12 for a subset of the corresponding autoencoder training data 66, and the segmentation metric can, for example, comprise the sum of squared differences between each pixel of the segmentation dataset and the corresponding pixel of the anomaly dataset 28.

Another option for the segmentation metric is a clipped cross entropy (CE) metric. Let yᵢ∈{0,1}, i=1, . . . , n denote expert annotations for a subset of pixels of the autoencoder training data 66 and let aᵢ denote the anomaly dataset 28 at pixel i, e.g., the difference between the imaging dataset 10 at pixel i and its reconstruction 26 at that pixel. Then the clipped cross entropy metric can be formulated as

$$CE ( a , y ) = \frac{1}{n} {\sum }_{i = 1}^{n} y \cdot log ( max ( 0 , min ( 1 , {a}_{i} ) ) ) + ( 1 - {y}_{i} ) \cdot log ( 1 - max ( 0 , min ( 1 , {a}_{i} ) ) ) .$$

Another option for the segmentation metric is the area under receiver-operator-characteristics curve (AUC). For a fixed threshold θ applied to the anomaly dataset 28 let

$${TPR}_{θ} := \frac{{TP}_{θ}}{{TP}_{θ} + {FN}_{θ}}$$

indicate the fraction of true positive pixels TP_{θ}, (defective pixels detected as defect), among all defective pixels, i.e., the sum of the true positive pixels TP_{θ}, and the false negative pixels FN_{θ} (defective pixels not detected as defect). Let

$${FPR}_{θ} := \frac{{FP}_{θ}}{{FP}_{θ} + {TN}_{θ}}$$

indicate the fraction of all false-positive pixels FP_{θ} (non-defective pixels detected as defect), among all non-defective pixels, i.e., the sum of the false positive pixels FP_{θ} and the true negative pixels TN_{θ} (non-defective pixels not detected as defect). Let each pair of (FPR_{θ}; TPR_{θ}) for different values of θ define a point on a curve with FPR_{θ} indicating the location on the horizontal axis and TPR_{θ} indicating the location on the vertical axis, then the AUC metric is the integral under this curve. The integral can be approximated in different ways, for example, by using the trapezoidal rule for a set of thresholds {θ₀, . . . , θₙ}:

$$AUC ( {θ}_{0} , … , {θ}_{n} ) := {\sum }_{i = 1}^{n} ( \frac{{TPR}_{{θ}_{i}} + {TPR}_{{θ}_{i - 1}}}{2} ) \cdot ( {FPR}_{{θ}_{i}} - {FPR}_{{θ}_{i - 1}} ) .$$

The logarithm of this metric can be used to make differences more pronounced.

Another option for the segmentation metric is the average precision (AP) metric. For a fixed threshold θ let

$${P}_{θ} := \frac{{TP}_{θ}}{{TP}_{θ} + {FP}_{θ}}$$

indicate the fraction of true positive pixels among all pixels classified as defect, and

$${R}_{θ} := \frac{{TP}_{θ}}{n}$$

indicate the fraction of true positive pixels among all n pixels. Let each pair of (R_{θ}; P_{θ}) for different values of θ define a point on a curve with R_{θ} indicating the location on the horizontal axis and P_{θ} indicating the location on the vertical axis, then the AP metric is the integral under this curve. The integral can be approximated in different ways, for example for a set of thresholds {θ_{θ}, . . . , θₙ} by:

$$AP ( {θ}_{0} , ... , {θ}_{n} ) := {\sum }_{i = 1}^{n} ( {R}_{{θ}_{i}} - {R}_{{θ}_{i - 1}} ) \cdot {P}_{{θ}_{i}}$$

Another option for the segmentation metric is the integral or maximum F1-score metric. Let

$${F}_{θ} := \frac{2 \cdot {P}_{θ} \cdot {R}_{θ}}{{P}_{θ} + {R}_{θ}} .$$

Then, for θ∈[0,1], the integral F1-score metric can be defined as

F1ᵢₙₜ:=∫_{θ}F_{θ}dθ,

and the maximum F1-score metric can be defined as

$$F {1}_{max} := {max}_{θ} {F}_{θ} .$$

Another option for the segmentation metric is the integral or maximum intersection over union (IoU) metric. Let

$${IoU}_{θ} := \frac{{TP}_{θ}}{{TP}_{θ} + {FP}_{θ} + {FN}_{θ}} .$$

Then, for θ∈[0,1], the integral intersection over union metric can be defined as

IoUᵢₙₜ:=∫_{θ}IoU_{θ}dθ,

and the maximum intersection over union metric can be defined as

$${IoU}_{max} := {max}_{θ} {IoU}_{θ} .$$

The above-described metrics AP, F1ᵢₙₜ, F1ₘₐₓ, IoUᵢₙₜ, IoUₘₐₓ cannot only be calculated on pixel-level, but also on instance-level, i.e., for defect instances. To evaluate a metric on instance-level, an annotation of defect instances is required as well as the determination of defect instances in the anomaly dataset, e.g., by computing connected components. Annotated defect instances and connected components of the anomaly dataset can then be matched and the respective metric can be computed.

Another option for the segmentation metric is the reconstruction error of non-defective regions (RNP). Let xᵢ denote the value of the imaging dataset at pixel i and yᵢ the value of pixel i in the reconstruction of the imaging dataset. Let, furthermore, [symbol] ⊂ [symbol] indicate the set of indices of all non-defective pixels and d: [symbol] × [symbol] → [symbol] an error metric. Then the reconstruction error of non-defective regions can be defined as

$$RNP ( x , y ) := \frac{1}{\vert 𝒫 \vert} {\sum }_{i ∈ 𝒫} d ( {x}_{i} , {y}_{i} ) .$$

For d(xᵢ,yᵢ)=(xᵢ−yᵢ)² the segmentation metric is denoted by MSE, for d(xᵢ,yᵢ)=|xᵢ−yᵢ| the segmentation metric is denoted by MAE.

Another option for the segmentation metric is the peak detection accuracy (PeakAcc) operating on image-level instead of pixel-level or instance-level. PeakAcc is defined as the fraction of correctly classified images within a set of images. An image is considered correctly classified if, for each detected defect, the distance of the pixel with the maximum anomaly dataset value is within a predefined radius of the closest defective pixel of the defect according to the expert annotations.

Any weighted combination of the above described metrics can be used as segmentation metric, e.g., MSE−AP, MSE−2·AP, 10·MSE−AP, MSE−log(AUC), 20·MSE−log(AUC), 10·MSE−PeakAcc.

According to an aspect of the example of the embodiment of the invention, the objective function can comprise a weighted sum of at least two terms measuring different properties of the trained autoencoder 24. Since all terms are optimized simultaneously and, thus, contribute to the value of the objective function, important properties of the autoencoder 24 apart from the reconstruction 26 quality in defect-free regions can be taken into account by the objective function. In this way, autoencoders 24 of improved accuracy can be obtained. For example, the autoencoder 24 can be prevented from reconstructing defects 12, or the computation time of a forward pass of the autoencoder 24 can be reduced.

The autoencoder 24 is required to reconstruct the defect-free parts of the imaging datasets 10 well. Therefore, the objective function can comprise an Lₚ-norm metric term for p≥1 measuring the deviation of the imaging dataset 10 from the reconstruction 26 of the imaging dataset 10. In this way, a good reconstruction 26 of the defect-free parts of the imaging dataset 10 can be achieved.

The objective function can comprise a term measuring the computation time of a forward pass of the trained autoencoder 24. In this way, potential application demands on runtime can be met.

The objective function can comprise a term measuring the complexity of the trained autoencoder 24. The complexity can refer to the variety of imaging datasets the autoencoder can reconstruct. The complexity of the trained autoencoder can, for example, refer to the number of trainable parameters of the autoencoder, e.g., to the number of weights or filter parameters, or to values of one or more specific hyperparameters, e.g., to the number and size of the layers or to the number of neurons of the autoencoder or to the size of the bottleneck. The complexity can also be measured by, e.g., the logarithm of the total number of floating-point operations (FLOP) in one forward-pass of the autoencoder 24. In this way, overfitting can be prevented and the structure of the autoencoder 24 can be kept small, thus saving memory and hardware resources.

The objective function can comprise a term measuring the compatibility of the trained autoencoder 24 with a specific hardware, e.g., by respecting a precision of the hardware or by optimizing channel sparsity.

According to an example of an embodiment of the invention, the generated autoencoder training data comprises expert annotations of defects 12 in the imaging datasets 10 of the objects 116, and the objective function comprises an Lₚ-norm metric term for p≥1 measuring the deviation of the imaging dataset 10 from the reconstruction 26 of the imaging dataset 10, a segmentation metric term comparing a subset of the anomaly dataset 28 to a subset of the expert annotations of the defects 12, and a term measuring the complexity of the trained autoencoder 24, e.g.,

$$f ( a , y ) = {w}_{1} \cdot {‖ a ‖}_{2}^{2} + {w}_{2} \cdot CE ( a , y ) + {w}_{3} \cdot log ( FLOP ) ,$$

where the weights w₁, w₂, w₃ are chosen by the expert. Typically, the first two weights are of similar magnitude whereas the third is at least ten times lower, e.g., w₁=10, w₂=1, w₃=0.01. Any of the segmentation metrics described above can be used in this objective function.

According to an aspect of an example of an embodiment of the invention, the objective function comprises a quality term evaluating the quality of the trained autoencoder 24, wherein a user interface is configured to present information on the trained autoencoder 24 to a user and let the user indicate the value of the quality term.

The objective function evaluates the quality of the one or more selected hyperparameter values. The evaluation of this function is computationally expensive, as it requires training an autoencoder and evaluating its performance on a validation dataset. As gradients of the objective function with respect to the hyperparameters are usually not available, optimization of the objective function is difficult and often relies on stochastic methods, which are based on selecting hyperparameter values according to a sampling strategy and comparing the objective function value to the objective function value of previously selected hyperparameter values.

Therefore, a hyperparameter optimization algorithm for optimizing the objective function can comprise two components: a sampling algorithm that selects which hyperparameter values are tried next according to a sampling strategy, and, optionally, a pruning algorithm that decides whether improvement of a configuration of hyperparameter values should be continued or interrupted.

In order to save the costly step of evaluating the objective function, a surrogate model called acquisition function can be fit to the previous guesses to obtain an educated guess for an improved solution. These methods are called Sequential Model-Based Optimization (SMBO). Different sampling strategies optimizing for different criteria can be employed.

For instance, one can use the Probability of improvement (PI) as an acquisition function, which evaluates the objective function f at the point most likely to improve upon the current objective function value. Let fₘᵢₙ denote the minimal value of f observed so far and D the previous observations. Then this corresponds to the following utility function associated with evaluating f at a given point x:

$$u ( x ) = \{ \begin{matrix}0 , & f ( x ) > {f}_{min} \\ 1 , & f ( x ) \leq {f}_{min}\end{matrix}$$

The probability of improvement acquisition function is then the expected utility as a function of X:

$${a}_{PI} ( x ) = E [ u ( x ) \vert x , D ] = {\int }_{- ∞}^{{f}_{min}} 𝒩 ( f ; μ ( x ) , K ( x , x ) ) df = Φ ( {f}_{min} ; μ ( x ) , K ( x , x ) )$$

where [symbol] denotes the density of the normal distribution, Φ the cumulative distribution function of the normal distribution, μ(x) its mean value and K(x,x) its variance. The point with the highest probability of improvement (the maximal expected utility) is then selected.

An alternative acquisition function that does account for the magnitude of the improvement is expected improvement (EI). Expected improvement evaluates f at the point that, in expectation, improves upon fₘᵢₙ the most. This corresponds to the following utility function:

$$u ( x ) = max ( 0 , {f}_{min} - f ( x ) ) .$$

The expected improvement acquisition function is then the expected utility as a function of x:

$${a}_{EI} ( x ) = E [ u ( x ) \vert x , D ] = {\int }_{- ∞}^{{f}_{min}} ( {f}_{min} - f ) 𝒩 ( f ; μ ( x ) , K ( x , x ) ) df = ( {f}_{min} - μ ( x ) ) Φ ( {f}_{min} ; μ ( x ) , K ( x , x ) ) + K ( x , x ) 𝒩 ( {f}_{min} ; μ ( x ) , K ( x , x ) ) .$$

The point with the highest expected improvement (the maximal expected utility) is selected. The expected improvement has two components. The first can be increased by reducing the mean function μ(x). The second can be increased by increasing the variance K(x; x). These two terms can be interpreted as explicitly encoding a tradeoff between exploitation (evaluating at points with low mean) and exploration (evaluating at points with high uncertainty). The exploitation-exploration tradeoff is a classic consideration in such problems, and the expected improvement criterion automatically captures both as a result of the Bayesian decision theoretic treatment.

An alternative acquisition function is typically known as upper confidence bound (UCB):

$${a}_{UCB} ( x ; β ) = μ ( x ) - βσ ( x )$$

where β>0 is a tradeoff parameter and σ(x)=\sqrt{K(x,x)} is the marginal standard deviation of f(x). Again, the UCB acquisition function contains explicit exploitation μ(x) and exploration σ(x) terms. Under certain conditions, the iterative application of this acquisition function will converge to the true global minimum of f.

An example for a preferred sampling algorithm, which is an SMBO approach optimizing the expected improvement, is a tree structured Parzen estimator (TPE).

A tree structured Parzen estimator (TPE) is a sampling algorithm which handles hyperparameters in a tree-structured fashion. For instance, the number of layers of a neural network and the number of neurons in each layer define a tree structure. For example, there cannot be a third layer without a second layer, and setting the number of neurons of a layer only makes sense if this layer exists in the graph.

TPE is based on the idea of estimating the probability density function l₁(x) of the best performing samples with respect to their objective function values and the probability density function l₂(x) of the remaining samples. The probability density functions are modeled by use of Parzen density estimators. The next hyperparameter value is then selected by optimizing the ratio

$$\frac{{l}_{1} ( x )}{{l}_{2} ( x )} .$$

Apart from TPE, there are other hyperparameter optimization methods, e.g., random search, hyperband (HP), Bayesian Optimization (BO), Bayesian Optimization and Hyperband (BOHB), Neural Architecture search (NAS), genetic algorithms, etc.

As an optional pruning algorithm an asynchronous successive halvings (ASHA) algorithm can be applied. The ASHA algorithm is a pruning strategy and a way to combine random search with early stopping in an asynchronous way.

Defect detection methods for integrated circuit patterns often suffer from high false positive rates, i.e., a lot of defect detections 73, which do not correspond to the norm (e.g., due to noise or varying imaging conditions), but are not detrimental to the functioning of the semiconductor device. Such false positives 76 should, therefore, ideally not be detected by integrated circuit pattern defect detection methods. Furthermore, defect detection methods often yield a number of false positives 76 due to imperfect knowledge of the imaging dataset 10, e.g., autoencoders usually do not perfectly reconstruct the imaging dataset 10 even if it does not contain defects.

In order to reduce the number of false positives 76, a defect identification method 72 is applied to the anomaly dataset 28 to obtain defect detections 73 by use of a defect criterion, in particular to distinguish defects 12 from false positives 76, in the defect identification step 22.

The defect criterion can be selected depending on the defect identification method 72. The defect criterion can, for example, comprise a threshold, e.g., a threshold applied to the anomaly dataset 28. In this way, only anomalies 36 with high reconstruction errors are marked as detected defects 73. The defect criterion can, for example, comprise a threshold applied to an output of a neural network, e.g., a minimum defect probability, a minimum class probability of one or more specific classes or a specific output value distribution. The defect criterion can, for example, comprise a minimum number of pixels forming a connected component, e.g., a minimum number of pixels forming a connected component in the anomaly dataset 28. The defect criterion can, for example, comprise a threshold or a set of intensity values in the imaging dataset 10. In this way, anomalies 36 having specific intensities are marked as detected defects 73. The defect criterion can, for example, comprise shape information, e.g., a form factor or a ratio of main axes of the anomalies 36. In this way, only anomalies of a specific shape are marked as detected defects 73. The defect criterion can, for example, comprise the location of the anomaly 36 within the imaging dataset 10. In this way, only anomalies 36 within specific regions of the imaging dataset 10 are marked as detected defects 73. The defect criterion, can for example, comprise a relation to neighboring anomalies 36 or to features within the imaging dataset 10. In this way, relative location information can be used to mark detected defects 73. Further defect criteria are conceivable.

Different examples of defect identification methods 72 are conceivable. According to an example of an embodiment of the invention, the defect identification method 72 comprises a defect segmentation method. In this way, prior knowledge about the nature or properties of defects 12 can be included. In an example, prior knowledge about defects 12 and false positives 76 can be included to distinguish between defects 12 and false positives 76.

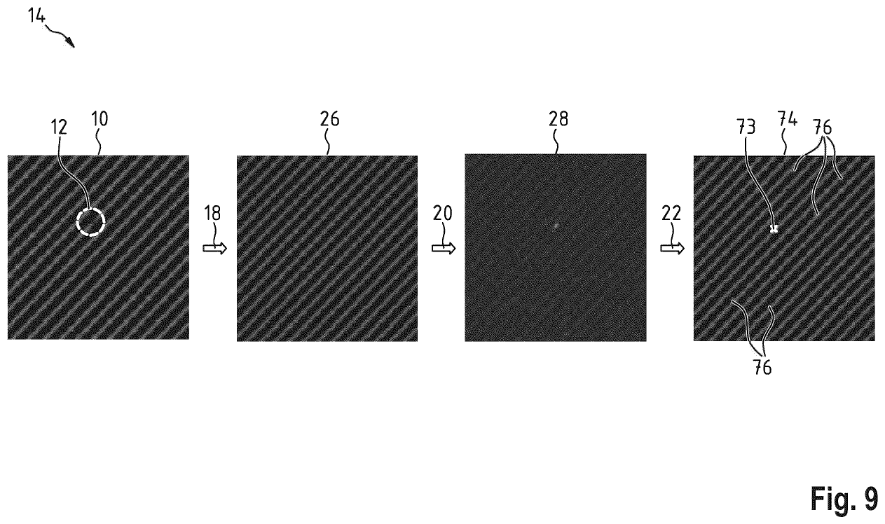

For example, FIG. 9 illustrates a computer implemented method 14 using a defect identification method 72 comprising a defect segmentation method, which comprises the application of a region growing algorithm to a smoothed anomaly dataset. In a reconstruction step 18, the imaging dataset 10 is reconstructed by use of an autoencoder 24 to obtain a reconstruction 26 of the imaging dataset 10. In an anomaly detection step 20, the anomaly dataset 28 is obtained by computing the difference of the imaging dataset 10 and the reconstruction 26. In a defect identification step 22, the defect identification method 72 is applied to the anomaly dataset 28 to detect defects 12 and discard false positives 76. According to the example of the defect identification method 72, the anomaly dataset 28 is first smoothed in order to reduce noise and increase the robustness of the method. Then a region growing algorithm is applied to the smoothed anomaly dataset to identify connected components representing the defects 12. The seeds are selected as pixels of the smoothed anomaly dataset with a value above a first threshold, i.e., pixels with a high reconstruction error. The region growing algorithm then associates all pixels of the smoothed anomaly dataset adjacent to the seed and with a value above a second threshold with the same defect 12. Thus, for each seed the connected component comprising the seed and all adjacent pixels of the smoothed anomaly dataset with values above a second threshold are assigned to the same defect 12. The second threshold can be lower or equal to the first threshold. Finally, for each connected component representing a defect 12 the center coordinate can be computed, e.g., by computing the centroid of all pixels or the mean value of all pixel coordinates. The defect detections 73 obtained by the defect identification method 72 can be represented as a defect dataset 74. The defect dataset 74 can, for example, comprise an imaging dataset with highlighted defect detections 73. The defect dataset 74 can, for example, comprise coordinates of the defect detections 73, e.g., by indicating the centroid, a bounding box, or a boundary line, etc. Alternative representations of the defect dataset 74 are conceivable. The defect dataset 74 in FIG. 9 indicates a correct defect detection 73 obtained by the defect identification method 72 corresponding to an anomaly 36 with high reconstruction error in the anomaly dataset 28. A number of false positives 76 also corresponding to anomalies 36 with high reconstruction errors in the anomaly dataset 28 were discarded by the defect identification method 72 and are, therefore, not part of the detected defects 73 or the defect dataset 74.

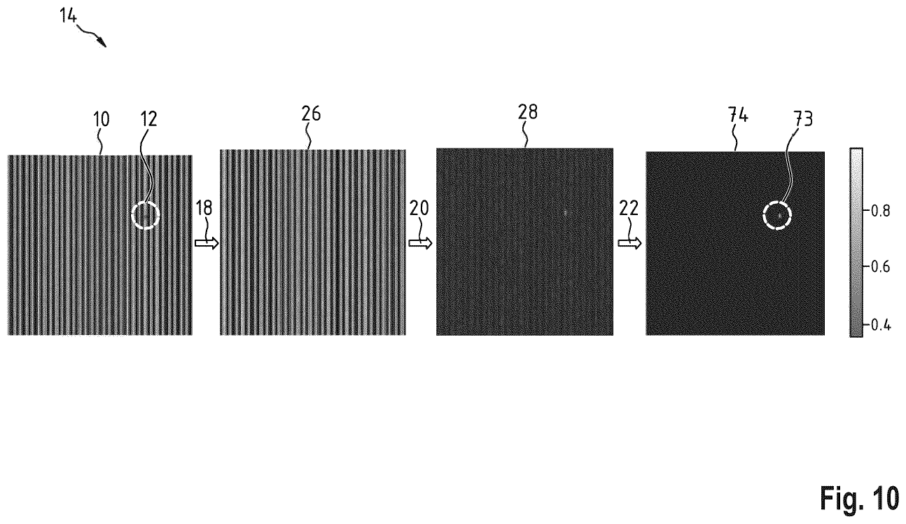

FIG. 10 illustrates a defect segmentation method 72 comprising the application of a machine learning segmentation model, in particular a deep learning segmentation model, to an anomaly dataset 28. The machine learning segmentation model can, for example, be trained on anomaly datasets 28 with labeled defects 12. In this way, the machine learning segmentation model is trained to suppress false positives 76 such as noise-like reconstruction errors, which, for example, often occur on boundaries of integrated circuit patterns. In FIG. 10, in a reconstruction step 18 the imaging dataset 10 is reconstructed by use of an autoencoder 24 to obtain the reconstruction 26 of the imaging dataset 10. In an anomaly detection step 20 the anomaly dataset 28 is obtained by computing the difference of the imaging dataset 10 and the reconstruction 26. In a defect identification step 22 the defect identification method 72 in the form of the machine learning segmentation model is applied to the anomaly dataset 28 yielding the defect dataset 74 showing a single defect detection 73 and suppressing all false positives 76.

Autoencoders 24 learn to reconstruct patterns contained in the training data. For logic operation integrated circuit patterns, which mostly contain complex polygon structures, often without repetitions or re-occurring sub-patterns, false positives 76 will occur. This is due to the fact, that the autoencoder 24 can only reconstruct integrated circuit patterns which are contained or at least similar to the autoencoder training data 66. Therefore, irregular patterns will lead to false positives 76.

To alleviate this problem the defect identification method 72 comprises generating an irregularity mask 90 indicating irregular patterns 104 in the integrated circuit patterns of the object 116. To this end, model design information about the object 116 can be used, e.g., a CAD file. Yet, this model design 82 is only required for detecting irregular patterns 104 before carrying out the defect detection process. The model design 82 is not required as a reference during defect detection, and it does not require rendering or simulation. Obtaining the irregularity mask 90 can comprise comparing a model design 82 of the object 116 to a regularized model design 86 of the object 116, wherein the regularized model design 86 is obtained from the model design 82 by replacing irregular patterns 104 by regular patterns. Defect detections 73 in these irregular patterns 104 can either be discarded or a separate defect detection method can be applied to the irregular patterns 104.

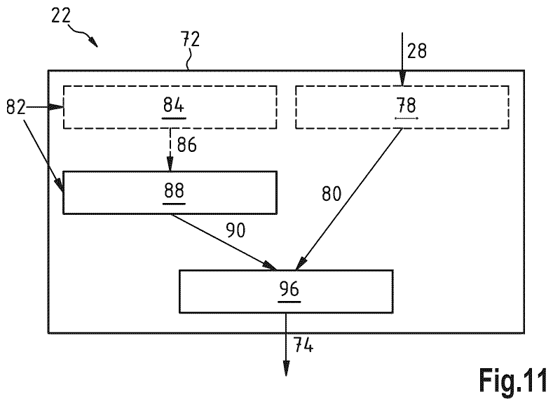

FIG. 11 illustrates a flowchart of a defect identification step 22 according to an example of an embodiment of the invention. The defect identification step 22 comprises a defect identification method 72, which comprises generating an irregularity mask 90 indicating irregular patterns 104 in the integrated circuit patterns of the object 116. The input to the defect identification method 72 is an anomaly dataset 28 generated as explained above. The defect identification method 72 can optionally comprise one or more preliminary defect identification methods 78 to obtain defect detections 73 by use of a defect criterion, in particular to distinguish defects 12 from false positives 76, e.g., the examples of the defect identification methods 72 described above with respect to FIGS. 9 and 10 could be used as preliminary defect identification methods 78. The preliminary defect identification method 78 yields a preliminary defect detection result 80, e.g., the defect datasets 74 in FIGS. 9 and 10. The preliminary one or more defect identification methods 78 are optional. Instead, the anomaly dataset 28 could be used as preliminary defect detection result 80. To identify irregular patterns 104, a model design 82 of the object 116 is obtained. The model design can contain the ideal integrated circuit patterns of the object without defects 12. A model design can be a CAD file of a photolithography mask or reticle or a CAD file of the wafer structures to be printed. In a regularization step 84, a regularized model design 86 of the object 116 is generated. In an irregularity mask generation step 88 an irregularity mask 90 is generated from the model design 82 and the regularized model design 86. In an irregularity mask application step 96 the irregularity mask 90 is applied to the preliminary defect detection result 80, yielding a defect dataset 74 representing the defect detections 73.

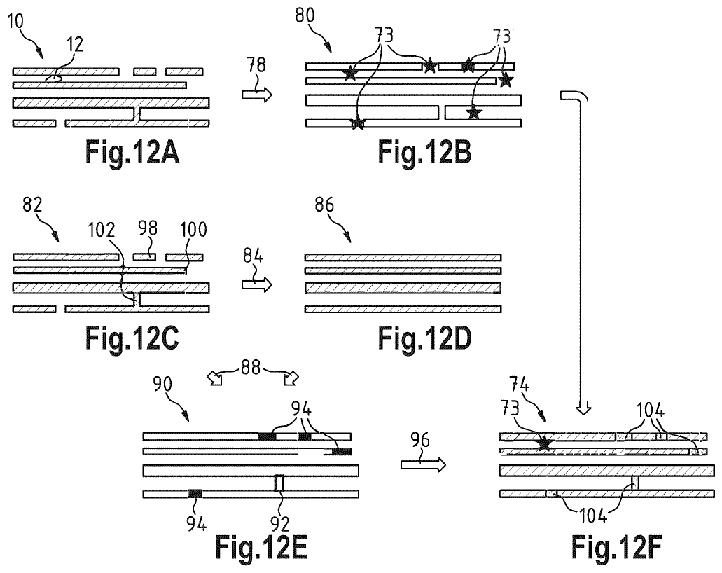

FIGS. 12A to 12F illustrate the steps of the defect identification step 22 illustrated in FIG. 11 for an object 116 comprising integrated circuit patterns, here a photolithography mask. In FIG. 12A an imaging dataset 10 including a defect 12 is shown. As described above, an anomaly dataset 28 is generated by applying an autoencoder 24 to the imaging dataset 10 and comparing the imaging dataset 10 to the reconstruction 26 of the imaging dataset 10. In an optional preliminary defect identification method 78, based on the anomaly dataset 28 preliminary defect detections 79 are obtained and false positives 76 discarded yielding a preliminary defect detection result 80 comprising the preliminary defect detections 79, which is shown in FIG. 12B. The preliminary defect identification method 78 is optional, so instead the anomaly dataset 28 can be used directly as preliminary defect detection result 80 comprising the anomalies 36 as preliminary defect detections 79. FIG. 12C shows the model design 82 of the object 116, that is of the photolithography mask. This object 116 exhibits some irregular patterns 104, e.g., a discontinued line 98, a line ending 100 and an (intended) bridge 102. Such irregular patterns 104 are rare and will, therefore, not be learned by the autoencoder 24. Thus, these patterns are marked as anomalies 36 and, thus, as defect detections 73, as can be seen in FIG. 12B. To avoid such false positives 76 due to irregular patterns 104 in the object 116, such irregular patterns 104 of the object 116 can be identified and handled by the defect identification method 72. To this end, in a regularization step 84, a regularized model design 86 as shown in FIG. 12D is generated from the model design 82 in FIG. 12C by replacing irregular patterns 104 by regular patterns. For example, discontinuous lines 98 are replaced by continuous lines, line endings 100 are extended to form a continuous line, line connections 102 are removed, etc. In this way, the regularized model design 86 is similar to the model design 82 but only contains regular patterns. Thus, the regularized model design 86 preserves the regular patterns of the model design 82 and modifies the irregular patterns 104 to become regular patterns. Ideally, the regularized model design would contain only regular patterns and deviate from the model design 82 as little as possible. The irregularity mask 90 is, then, obtained by comparing the model design 82 of the object 116 to the regularized model design 86 of the object 116. Therefore, in the irregularity mask generation step 88 the model design 82 and the regularized model design 86 are combined to form an irregularity mask 90, which indicates irregular patterns 104 of the object 116. For example, as shown in FIG. 12E, obtaining the irregularity mask 90 can comprise applying a logical XOR function to the model design 82 of the object 116 and the regularized model design 86 of the object 116. The model design 82 and the regularized model design 86 can be binarized before applying the XOR function. In this way, patterns only appearing in one of the designs 82, 86 are preserved, whereas patterns appearing in both designs 82, 86 are removed. The patterns which are preserved are denoted as irregular patterns 104. For example, the missing patterns 94 of the model design 82 only appear in the regularized model design 86, so they are preserved in the irregularity mask 90. The additional pattern 92 of the model design 82 only appears in the model design 82, so it is preserved in the irregularity mask 90. Thus, the irregularity mask 90 comprises irregular patterns 104 comprising the additional patterns 92 and the missing patterns 94. The irregularity mask 90 can be used in different ways to identify defects 12. For example, as shown in FIG. 12F, the preliminary defect detection result 80 can be filtered by the irregularity mask 90, thus removing all defect detections 73 contained in an irregular pattern 104 identified by the irregularity mask 90.

The regularized model design 86 can be obtained from the model design 82 in different ways. For example, obtaining the regularized model design 86 can comprise applying a machine learning model to the model design 82 of the object 116, the machine learning model being trained to replace irregular patterns 104 by regular patterns. For example, combinations of model designs 82 comprising irregular patterns 104 and corresponding regularized model designs 86 can be used for training of the machine learning model. In another example, obtaining the regularized model design 86 comprises using a user interface 128 configured for letting a user indicate regularized patterns of the model design 82, e.g., by drawing or removing integrated circuit patterns or by copying regular integrated circuit patterns from other parts of the model design 82. In another example, obtaining the regularized model design 86 comprises loading data from a database 130. The regularized model design 86 can also be included in the model design 82, e.g., it can be modeled by the designer and included in the CAD file. Further methods for obtaining a regularized model design 86 from a model design 82 are conceivable.

It is also possible to directly obtain an irregularity mask 90 from a model design 82 without generating a regularized model design 86 first, that is by skipping the regularization step 84. For example, obtaining the irregularity mask 90 can comprise applying a machine learning model to the model design 82 of the object 116, the machine learning model being trained to identify irregular patterns 104. For example, the machine learning model can be a classification model, e.g., a convolutional neural network, for irregular patterns 104. The machine learning model can also be an autoencoder trained on regular patterns, so the reconstruction fails for irregular patterns 104, which can thus be detected. In another example, obtaining the irregularity mask 90 comprises using a user interface 128 configured for letting a user indicate irregular patterns 104 of the model design 82. In another example, information on irregular patterns 104 of an object 116, e.g., the irregularity mask 90, can be loaded from a database 130, or it is included in the model design 82, e.g., in the CAD file. Other ways of obtaining the irregularity mask 90 directly from the model design 82 are conceivable.

The irregularity mask 90 can be used in different ways to discard false positives 76 while preserving correct defect detections 73. According to an example of an embodiment of the invention, the defect identification method 72 ignores defect detections 73 occurring within the irregular patterns 104 indicated by the irregularity mask 90, e.g., by using the irregularity mask 90 as a filter (see FIG. 12F).

According to an example of an embodiment of the invention, the defect identification method 72 comprises an irregular defect detection method 103 for the detection of defects in irregular patterns 104, which is applied to the irregular patterns 104 indicated by the irregularity mask 90. The irregular defect detection method 103 for the detection of defects 12 in irregular patterns 104 can, for example, comprise the application of a machine learning model, in particular a second autoencoder 108, trained on training data comprising irregular patterns 104. In an example, the training data is generated from irregular patterns 104 indicated by irregularity masks 90 of imaging datasets 10 of objects comprising integrated circuit patterns and/or of model designs 82 of objects comprising integrated circuit patterns. In this way, the training data only contains irregular patterns 104, e.g., hard corners, line endings or non-continuous lines. The irregular defect detection method 103 can, for example, be designed as described above, e.g., comprising a reconstruction step 18, an anomaly detection step 20 and, optionally, a defect identification step 22.

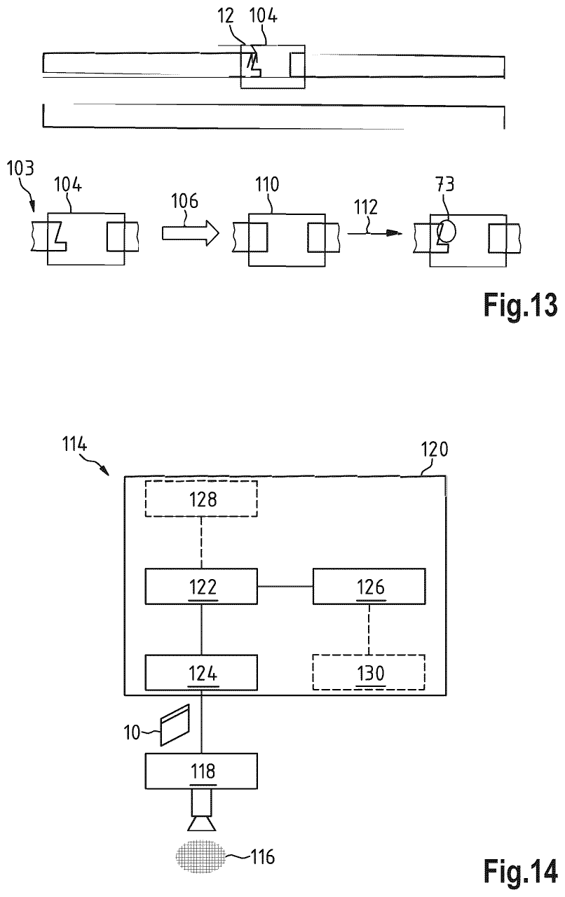

FIG. 13 illustrates the application of an irregular defect detection method 103 to an irregular pattern 104. In a reconstruction step 106, a machine learning model, e.g., a second autoencoder 108, is applied to the irregular pattern 104 yielding the reconstruction 110. In an anomaly detection step 112 anomalies 36 can be detected by comparing the irregular pattern 104 to the reconstruction 110 of the irregular pattern 104. In addition, defect identification methods 72 as described above, e.g., defect segmentation methods, can be applied to obtain defect detections 73 by use of a defect criterion, in particular to distinguish defect detections 73 from false positives 76, within irregular patterns 104.

According to an example of an embodiment of the invention, subsets of the imaging dataset 10 are successively acquired, in particular via time-delayed integration, and for each acquired subset defects 12 are detected in an online fashion. Whenever a suitable number of lines is available for inspection the defect detection algorithm can be applied to these lines. Preferably, the size of the inspected subsets is at least three times the minimal feature size. This allows for more reliable reconstructions 26 and, thus, defect detections of improved accuracy. For example, the autoencoder can be applied to reconstruct 4092×92 px imaging datasets. In this case, the design of the autoencoder 24 might need to be adapted, e.g., to be asymmetric in width versus height, or the overall model depth must be restricted. By using the defect detection algorithm in an online fashion, the throughput can be increased.

According to an example of an embodiment of the invention, one or more measurements of the detected defects 12 can be obtained, in particular size, area, dimension, shape parameters, distance, radius, aspect ratio, type, number of defects, location, density, spatial distribution of defects, existence of defects, etc. Based on these measurements and possibly a set of rules, quality assessment of the inspected objects 116 can be carried out. For example, a decision can be taken if a photolithography mask or reticle can be repaired or must be discarded, or if a wafer is still acceptable or must be discarded.

According to the techniques described herein, various imaging modalities may be used to acquire an imaging dataset 10 for the detection of defects 12. Along with the various imaging modalities, it would be possible to obtain different imaging data sets 10. Imaging datasets 10 can comprise single-channel images or multi-channel images, e.g., focus stacks. For instance, it would be possible that the imaging dataset 10 includes 2-D images. Here, it would be possible to employ a multi beam scanning electron microscope (mSEM). mSEM employs multiple beams to acquire contemporaneously images in multiple fields of view. For instance, a number of not less than 50 beams could be used or even not less than 90 beams. Each beam covers a separate portion of a surface of the object 116. Thereby, a large imaging dataset 10 is acquired within a short duration of time. Typically, 4.5 gigapixels are acquired per second. For illustration, one square centimeter of a wafer can be imaged with 2 nm pixel size leading to 25 terapixel of data. Other examples for imaging datasets 10 including 2D images would relate to imaging modalities such as optical imaging, phase-contrast imaging, x-ray imaging, etc. It would also be possible that the imaging dataset is a volumetric 3-D dataset, which can be processed slice-by-slice or as a three-dimensional volume. Here, a crossbeam imaging device including a focused-ion beam (FIB) source, an atomic force microscope (AFM) or a scanning electron microscope (SEM) could be used. Multimodal imaging datasets may be used, e.g., a combination of x-ray imaging and SEM.

An example of an embodiment of the invention involves a computer-readable medium having stored thereon a computer program executable by a computing device, the computer program comprising code for executing one of the methods described above.

An example of an embodiment of the invention involves a computer program product comprising instructions which, when the program is executed by a computer, cause the computer to carry out one of the methods described above.

An example of an embodiment of the invention involves a system 114 for inspecting an object 116 comprising integrated circuit patterns to detect defects 12, the system comprising: an imaging device 118 adapted to provide an imaging dataset 10 of an object 116 comprising integrated circuit patterns; one or more processing devices 120; one or more machine-readable hardware storage devices comprising instructions that are executable by one or more processing devices 120 to perform operations comprising one of the methods described above.

FIG. 14 schematically illustrates a system 114, which can be used for inspecting an object 116 for defects 12. The system 114 includes an imaging device 118 and a processing device 120. The imaging device 118 is coupled to the processing device 120, e.g., via cable or wireless. They can be located in the same room, in the same lab, in the same fab or in different buildings. The imaging device 118 is configured to acquire imaging datasets 10 of the object 116. The object 116 comprises integrated circuit patterns, e.g., transistors such as field effect transistors, memory cells, et cetera. An example implementation of the imaging device 118 would be a SEM, a Helium ion microscope (HIM), a cross-beam device including FIB and SEM or any charged particle imaging device. In a preferred embodiment, time-delayed integration (TDI) is used for scanning a photolithography mask. For example, a photolithography mask of 10 to 12 cm can be split into 220 lines covering 100,000 pixels in width, which are scanned consecutively. In another example, an aerial image measurement system is used for obtaining the imaging dataset, e.g., equipped with a staring array sensor or a line-scanning sensor or a time-delayed integration (TDI) sensor. An aerial image is the radiation intensity distribution at substrate level.

The imaging device 118 can provide an imaging dataset 10 to the processing device 120. The processing device 120 includes a processor 122, e.g., implemented as a CPU or GPU. The processor 122 can receive the imaging dataset 10 via an interface 124. The processor 122 can load program code from a memory 126. The processor 122 can execute the program code. Upon executing the program code, the processor 122 performs techniques such as described herein, e.g., applying an autoencoder 24 to an imaging dataset 10 to obtain a reconstruction 26, comparing the imaging dataset 10 to its reconstruction 26 to detect anomalies 36, applying a defect identification method 72 to an anomaly dataset 28, training an autoencoder 24, optimizing hyperparameters of the autoencoder 24, computing irregularity masks 90, generating regularized model designs 86 from model designs 82, applying an irregular defect detection method 103, etc. For example, the processor 122 can perform the computer implemented method shown in FIG. 2 or FIG. 7 or FIG. 11 respectively upon loading program code from the memory 126. The processing device 120 can optionally contain a user interface 128 and/or a database 130.

The methods disclosed herein can, for example, be used during research and development of objects comprising integrated circuit patterns or during high volume manufacturing of objects comprising integrated circuit patterns, or for process window qualification or enhancement. In addition, the methods disclosed herein can also be used for defect detection of X-ray imaging datasets of objects comprising integrated circuit patterns, e.g., after packaging the semiconductor device for delivery.

It is noted that the methods and systems described herein can, for example, be used for defect detection in photolithography masks, in particular for EUV photolithography masks.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment,” “according to an example” or “according to an aspect” in various places throughout this specification are not necessarily all referring to the same embodiment, example or aspect, but may. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The following clauses contain preferred embodiments of the invention:
1. A computer implemented method 14 for the detection of defects 12 in an imaging dataset 10 of an object 116 comprising integrated circuit patterns, the method comprising:
   Obtaining an imaging dataset 10 of the object 116;
   Applying an autoencoder 24 neural network to the imaging dataset 10 to obtain a reconstruction 26 of the imaging dataset 10;
   Obtaining an anomaly dataset 28 by comparing the imaging dataset 10 to the reconstruction 26 of the imaging dataset 10;
   Applying a defect identification method 72 to the anomaly dataset 28 to obtain defect detections 73 by use of a defect criterion.
2. The method according to clause 1, the autoencoder 24 neural network having been trained comprising the following steps:
   Generating autoencoder training data 66 from imaging datasets 10 of objects 116 comprising integrated circuit patterns;
   Iterating the following steps:
      i. Selecting one or more hyperparameter values for one or more hyperparameters of an autoencoder 24 neural network according to a sampling strategy;
      ii. Training the autoencoder 24 based on subsets of the generated autoencoder training data 66 and the selected one or more hyperparameter values;
      iii. Evaluating the trained autoencoder 24 by computing an associated objective function value of an objective function;
   Selecting one of the trained autoencoders 24 based on the associated objective function value.
3. The method according to clause 2, wherein the generated autoencoder training data 66 comprises expert annotations of defects 12 in the imaging datasets 10 of objects 116 comprising integrated circuit patterns.
4. The method according to clause 3, wherein a subset of the expert annotations is used as validation data during the training of the autoencoder 24.
5. The method according to any one of clauses 2 to 4, wherein the objective function comprises a segmentation metric term comparing a subset of the anomaly dataset 28 to a subset of the expert annotations of the defects 12.
6. The method according to any one of clauses 2 to 5, wherein the objective function comprises a weighted sum of at least two terms measuring different properties of the trained autoencoder 24.
7. The method according to any one of clauses 2 to 6, wherein the objective function comprises an Lₚ-norm metric term for p≥1 measuring the deviation of the imaging dataset 10 from the reconstruction 26 of the imaging dataset 10.
8. The method according to any one of clauses 2 to 7, wherein the objective function comprises a term measuring the computation time of a forward pass of the trained autoencoder 24.
9. The method according to any one of clauses 2 to 8, wherein the objective function comprises a term measuring the complexity of the trained autoencoder 24.
10. The method according to any one of clauses 2 to 9, wherein the objective function comprises a term measuring the compatibility of the trained autoencoder 24 with a specific hardware.
11. The method according to clause 3, wherein the objective function comprises an Lₚ-norm metric term for p≥1 measuring the deviation of the imaging dataset 10 from the reconstruction 26 of the imaging dataset 10, a segmentation metric term comparing a subset of the anomaly dataset 28 to a subset of the expert annotations of the defects 12, and a term measuring the complexity of the trained autoencoder 24.
12. The method of any one of clauses 2 to 11, wherein the objective function comprises a quality term evaluating the quality of the trained autoencoder 24, and wherein a user interface 128 is configured to present information on the trained autoencoder 24 to a user and let the user indicate the value of the quality term.
13. The method according to any one of the preceding clauses, wherein the defect identification method 72 comprises a defect segmentation method.
14. The method according to clause 13, wherein the defect segmentation method comprises applying a region growing algorithm to a smoothed anomaly dataset.
15. The method according to clause 13 or 14, wherein the defect segmentation method comprises applying a machine learning segmentation model, in particular a deep learning segmentation model, to the anomaly dataset 28.
16. The method according to any one of the preceding clauses, wherein the defect identification method 72 comprises generating an irregularity mask 90 indicating irregular patterns 104 in the integrated circuit patterns of the object 116.
17. The method according to clause 16, wherein obtaining the irregularity mask 90 comprises comparing a model design 82 of the object 116 to a regularized model design 86 of the object 116, wherein the regularized model design 86 is obtained from the model design 82 by replacing irregular patterns by regular patterns.
18. The method according to clause 17, wherein obtaining the regularized model design 86 comprises applying a machine learning model to the model design 82 of the object 116, the machine learning model being trained to replace irregular patterns by circuit patterns.
19. The method according to clause 17 or 18, wherein obtaining the regularized model design 86 comprises using a user interface 128 configured for letting a user indicate regularized patterns of the model design 82.
20. The method according to any one of clauses 17 to 19, wherein obtaining the regularized model design 86 comprises loading data from a database 130, or wherein the regularized model design 86 is included in the model design 82.
21. The method according to any one of clauses 17 to 20, wherein obtaining the irregularity mask 90 comprises applying a logical XOR function to the model design 82 of the object 116 and the regularized model design 86 of the object 116.
22. The method according to clause 16, wherein obtaining the irregularity mask 90 comprises applying a machine learning model to the model design 82 of the object 116, the machine learning model being trained to identify irregular patterns.
23. The method according to clause 16 or 22, wherein obtaining the irregularity mask 90 comprises loading data from a database 130, or wherein the irregularity mask 90 is included in the model design 82.
24. The method according to clause 16, 22 or 23, wherein obtaining the irregularity mask 90 comprises using a user interface 128 configured for letting a user indicate irregular patterns of the model design 82.
25. The method according to any one of clauses 16 to 24, wherein the defect identification method 72 ignores defects 12 occurring within the irregular patterns 104 indicated by the irregularity mask 90.
26. The method according to any one of clauses 16 to 24, wherein the defect identification method 72 comprises an irregular defect detection method 103 for the detection of defects 12 in irregular patterns, which is applied to the irregular patterns 104 indicated by the irregularity mask 90.
27. The method according to clause 26, wherein the irregular defect detection method 103 for the detection of defects 12 in irregular patterns comprises applying a machine learning model, in particular a second autoencoder 106, trained on training data comprising irregular patterns.
28. The method according to clause 27, wherein the training data is generated from irregular patterns 104 indicated by irregularity masks 90 of imaging datasets 10 of objects 116 and/or of model designs 82 of objects 116.
29. The method according to any one of clauses 1 to 28, wherein subsets of the imaging dataset 10 are successively acquired, in particular via time-delayed integration, and for each acquired subset defects 12 are detected in an online fashion.
30. The method according to any one of the preceding clauses, further comprising determining one or more measurements of the detected defects 12, in particular size, area, dimension, shape parameters, distance, radius, aspect ratio, type, number of defects, location, density, spatial distribution of defects, existence of defects, etc.
31. The method according to any one of clauses 1 to 30, wherein the object 116 comprising integrated circuit patterns is a photolithography mask.
32. The method according to any one of clauses 1 to 30, wherein the object 116 comprising integrated circuit patterns is a wafer.
33. The method according to any one of the preceding clauses, wherein obtaining defect detections 73 comprises distinguishing defects 12 from false positives 76.
34. The method according to any one of the preceding clauses, wherein the autoencoder is trained using simulated imaging datasets 10 for a first number of training cycles and using acquired imaging datasets 10 for a second number of training cycles.
35. The method according to any one of the preceding clauses, wherein the imaging dataset 10 of the object 116 is obtained by an image acquisition method from the group comprising time-delayed integration, x-ray imaging, scanning electron microscopy, focused ion beam microscopy, atomic force microscopy, aerial imaging.
36. A computer-readable medium, having stored thereon a computer program executable by a computing device, the computer program comprising code for executing a method of any one of clauses 1 to 35.
37. A computer program product comprising instructions which, when the program is executed by a computer, cause the computer to carry out a method of any one of clauses 1 to 35.
38. A system 114 for inspecting an object 116 comprising integrated circuit patterns to detect defects 12, the system comprising:
   an imaging device 118 adapted to provide an imaging dataset 10 of an object 116 comprising integrated circuit patterns;
   one or more processing devices 120;
   one or more machine-readable hardware storage devices comprising instructions that are executable by the one or more processing devices 120 to perform operations comprising a method of any one of clauses 1 to 35.

In a general aspect, a computer implemented method 14 for the detection of defects 12 in an imaging dataset 10 of an object comprising integrated circuit patterns is disclosed, the method comprising: obtaining an imaging dataset 10 of the object; applying an autoencoder neural network to the imaging dataset 10 to obtain a reconstruction 26 of the imaging dataset 10; obtaining an anomaly dataset 28 by comparing the imaging dataset 10 to the reconstruction 26 of the imaging dataset 10; applying a defect identification method to the anomaly dataset 28 to obtain defect detections 73 by use of a defect criterion wherein the defect identification method comprises generating an irregularity mask indicating irregular patterns in the integrated circuit patterns of the object. The invention also relates to a corresponding computer-readable medium, computer program product and system.

### REFERENCE NUMBER LIST

10 Imaging dataset
12 Defect
14 Computer implemented method
16 Image acquisition step
18 Reconstruction step
20 Anomaly detection step
22 Defect identification step
24 Autoencoder
26 Reconstruction
28 Anomaly dataset
32 Encoder
34 Input
36 Anomaly
38 Stem
40 Downsampling blocks
42 Downsampling and channel expansion blocks
44 Channel compression layers
46 Bottleneck
48 First reconstruction
50 Second reconstruction
52 Hyperparameter optimization method
54 Training data generation step
56 Hyperparameter selection step
58 Training step
60 Evaluation step
62 Selection step
64 Iterations
66 Autoencoder training data
68 Horizontal axis
70 Vertical axis
72 Defect identification method
73 Defect detection
74 Defect dataset
76 False positive
78 Preliminary defect identification method
79 Preliminary defect detection
80 Preliminary defect detection result
82 Model design
84 Regularization step
86 Regularized model design
88 Irregularity mask generation step
90 Irregularity mask
92 Additional pattern
94 Missing pattern
96 Irregularity mask application step
98 Discontinuous line
100 Line ending
102 Bridge
103 Irregular defect detection method
104 Irregular pattern
106 Reconstruction step
108 Second autoencoder
110 Reconstruction
112 Anomaly detection step
114 System
116 Object
118 Imaging device
120 Processing device
122 Processor
124 Interface
126 Memory
128 User interface
130 Database

What is claimed is:

1. A computer implemented method for the detection of defects in an imaging dataset of an object comprising integrated circuit patterns, the method comprising:
obtaining an imaging dataset of the object;
applying an autoencoder neural network to the imaging dataset to obtain a reconstruction of the imaging dataset;
obtaining an anomaly dataset by comparing the imaging dataset to the reconstruction of the imaging dataset; and
applying a defect identification method to the anomaly dataset to obtain defect detections by means of a defect criterion, wherein the defect identification method comprises generating an irregularity mask indicating irregular patterns in the integrated circuit patterns of the object.

2. The method according to claim 1, the autoencoder neural network having been trained comprising the following steps:
generating autoencoder training data from imaging datasets of objects comprising integrated circuit patterns;
iterating the following steps:
i. selecting one or more hyperparameter values for one or more hyperparameters of an autoencoder neural network according to a sampling strategy;
ii. training the autoencoder based on subsets of the generated autoencoder training data and the selected one or more hyperparameter values;
iii. evaluating the trained autoencoder by computing an associated objective function value of an objective function; and
selecting one of the trained autoencoders based on the associated objective function value.

3. The method according to claim 2, wherein the generated autoencoder training data comprises expert annotations of defects in the imaging datasets of objects comprising integrated circuit patterns.

4. The method according to claim 3, wherein a subset of the expert annotations is used as validation data during the training of the autoencoder.

5. The method according to claim 2, wherein the objective function comprises a segmentation metric term comparing a subset of the anomaly dataset to a subset of the expert annotations of the defects.

6. The method according to claim 2, wherein the objective function comprises a weighted sum of at least two terms measuring different properties of the trained autoencoder.

7. The method according to claim 2, wherein the objective function comprises an Lₚ-norm metric term for p≥1 measuring the deviation of the imaging dataset from the reconstruction of the imaging dataset.

8. The method according to claim 2, wherein the objective function comprises a term measuring the computation time of a forward pass of the trained autoencoder.

9. The method according to claim 2, wherein the objective function comprises a term measuring the complexity of the trained autoencoder.

10. The method according to claim 2, wherein the objective function comprises a term measuring the compatibility of the trained autoencoder with a specific hardware.

11. The method according to claim 3, wherein the objective function comprises an Lₚ-norm metric term for p≥1 measuring the deviation of the imaging dataset from the reconstruction of the imaging dataset, a segmentation metric term comparing a subset of the anomaly dataset to a subset of the expert annotations of the defects, and a term measuring the complexity of the trained autoencoder.

12. The method according to claim 2, wherein the objective function comprises a quality term evaluating the quality of the trained autoencoder, and wherein a user interface is configured to present information on the trained autoencoder to a user and let the user indicate the value of the quality term.

13. The method according to claim 1, wherein the defect identification method comprises a defect segmentation method.

14. The method according to claim 13, wherein the defect segmentation method comprises applying a region growing algorithm to a smoothed anomaly dataset.

15. The method according to claim 13, wherein the defect segmentation method comprises applying a machine learning segmentation model, in particular a deep learning segmentation model, to the anomaly dataset.

16. The method according to claim 1, wherein obtaining the irregularity mask comprises comparing a model design of the object to a regularized model design of the object, wherein the regularized model design is obtained from the model design by replacing irregular patterns by regular patterns.

17. The method according to claim 16, wherein obtaining the regularized model design comprises applying a machine learning model to the model design of the object, the machine learning model being trained to replace irregular patterns by regular patterns.

18. The method according to claim 16, wherein obtaining the regularized model design comprises using a user interface configured for letting a user indicate regularized patterns of the model design.

19. The method according to claim 16, wherein obtaining the regularized model design comprises loading data from a database, or wherein the regularized model design is included in the model design.

20. The method according to claim 16, wherein obtaining the irregularity mask comprises applying a logical XOR function to the model design of the object and the regularized model design of the object.

21. The method according to claim 1, wherein obtaining the irregularity mask comprises applying a machine learning model to the model design of the object, the machine learning model being trained to identify irregular patterns.

22. The method according to claim 1, wherein obtaining the irregularity mask comprises loading data from a database, or wherein the irregularity mask is included in the model design.

23. The method according to claim 1, wherein obtaining the irregularity mask comprises using a user interface configured for letting a user indicate irregular patterns of the model design.

24. The method according to claim 1, wherein the defect identification method ignores defects occurring within the irregular patterns indicated by the irregularity mask.

25. The method according to claim 1, wherein the defect identification method comprises an irregular defect detection method for the detection of defects in irregular patterns, which is applied to the irregular patterns indicated by the irregularity mask.

26. The method according to claim 25, wherein the irregular defect detection method for the detection of defects in irregular patterns comprises applying a machine learning model, in particular a second autoencoder, trained on training data comprising irregular patterns.

27. The method according to claim 1, wherein the autoencoder is trained using simulated imaging datasets for a first number of training cycles and using acquired imaging datasets for a second number of training cycles.

28. A computer-readable medium, having stored thereon a computer program executable by a computing device, the computer program comprising code for executing a method of claim 1.

29. A computer program product comprising instructions which, when the program is executed by a computer, cause the computer to carry out a method of claim 1.

30. A system for inspecting an object comprising integrated circuit patterns to detect defects, the system comprising:
an imaging device adapted to provide an imaging dataset of an object comprising integrated circuit patterns;
one or more processing devices; and
one or more machine-readable hardware storage devices comprising instructions that are executable by the one or more processing devices to perform operations comprising a method of claim 1.
